(19) United States
(12) Patent Application Publication
(10) Pub. No.: US 2026/0065847 A1
(43) Pub. Date: Mar. 5, 2026

(54) DISPLAY PANEL AND DISPLAY DEVICE

(71) Applicant: Xiamen Tianma Display Technology Co., Ltd., Xiamen (CN)

(72) Inventor: Qingjun LAI, Xiamen (CN)

(21) Appl. No.: 19/239,135

(22) Filed: Jun. 16, 2025

(30) Foreign Application Priority Data
Sep. 2, 2024 (CN) 202411222890.0

(51) Int. Cl. G09G 3/32

(52) U.S. Cl. CPC G09G 3/32; G09G 2300/0814; G09G 2300/0819; G09G 2310/0267; G09G 2310/0286; G09G 2310/0294; G09G 2310/08; G09G 2320/0233; G09G 2330/021

(57) ABSTRACT

Display panel and display device are provided. The display panel includes driving circuit including a cascaded N-stage shift register. A stage of the cascaded N-stage shift register includes: shift control module, configured to at least receive an input signal and control signals of a first node and a second node; shift output module, configured to at least receive the signals of the first node and the second node, and control a shift signal; selection control module, configured to at least receive the shift signal and a selection control signal, and control a time for transmitting the selection control signal to the third node; output control module, configured to at least receive the shift signal and a signal of a third node, and control a signal of a fourth node; and signal output module, configured to at least receive the signal of the fourth node, and control a gate driving signal.

### CROSS-REFERENCE TO RELATED APPLICATION

The present disclosure claims priority of Chinese Patent Application No. 202411222890.0, filed on Sep. 2, 2024, the entire content of which is hereby incorporated by reference.

### FIELD OF THE DISCLOSURE

The present disclosure generally relates to the field of display technology and, more particularly, relates to a display panel and a display device.

### BACKGROUND

A display panel is usually provided with a plurality of pixels arranged in an array. By scanning each pixel line by line with a driving circuit, data signals may be written into each pixel line by line. As such, each pixel may display and emit light according to the data signals received by the pixel, and a corresponding image may thus be displayed.

When a display panel displays an image, the higher the refresh rate of the display panel, the shorter the pixel scanning period, and thus the higher power consumption of the display panel. Lowering the refresh rate may reduce the power consumption of the display panel. However, a lower refresh rate may affect the display quality of certain specific displays, such as videos, games, etc. As such, how to reduce the power consumption of the display panel without affecting the image display quality is a technical problem that needs to be solved urgently.

### SUMMARY

One aspect of the present disclosure includes a display panel. The display panel includes a driving circuit. The driving circuit includes a cascaded N-stage shift register, and the cascaded N-stage shift register includes N stages of shift registers. A stage of shift register of the N stages of shift registers includes: a shift control module, configured to at least receive an input signal and control a signal of a first node and a signal of a second node; a shift output module, configured to at least receive the signal of the first node and the signal of the second node, and control a shift signal; a selection control module, configured to at least receive the shift signal and a selection control signal, and control a time for the selection control signal to be transmitted to the third node according to the shift signal; an output control module, configured to at least receive the shift signal and a signal of a third node, and control a signal of a fourth node; and a signal output module, configured to at least receive the signal of the fourth node, and control a gate driving signal. An enable level start time of the shift signal of each stage of shift register of the N stages of shift registers is shifted in sequence; and the shift signal output by an x-th stage shift register of the N stages of shift registers is the input signal received by a y-th stage shift register of the N stages of shift registers, where 1≤x≤N, 1≤y≤N, x≠y, and x, y and N each are positive integers.

Another aspect of the present disclosure includes a display panel. The display panel includes a driving circuit. The driving circuit includes a cascaded N-stage shift register, and the cascaded N-stage shift register includes N stages of shift registers. A stage of shift register of the N stages of shift registers includes: a shift control module, configured to at least receive an input signal, and control a signal of a first node and a signal of a second node; a shift output module, configured to at least receive the signal of the first node and the signal of the second node, and control a shift signal; an output control module, configured to at least receive a selection control signal and the shift signal, and control a signal of a fourth node; and a signal output module, configured to at least receive the signal of the fourth node and control output of a gate driving signal. In a display time of a frame, in the cascaded N-stage shift register, the stage of shift register that outputs the gate driving signal that includes an enable level is a third shift register. In the third shift register, an enable level time of the gate driving signal is equal to an enable level time of the shift signal.

Another aspect of the present disclosure includes a display device. The display device includes a display panel. The display panel includes a driving circuit, where the driving circuit includes a cascaded N-stage shift register. The cascaded N-stage shift register includes N stages of shift registers. A stage of shift register of the N stages of shift registers includes: a shift control module, configured to at least receive an input signal and control a signal of a first node and a signal of a second node; a shift output module, configured to at least receive the signal of the first node and the signal of the second node, and control a shift signal; a selection control module, configured to at least receive the shift signal and a selection control signal, and control a time for the selection control signal to be transmitted to the third node according to the shift signal; an output control module, configured to at least receive the shift signal and a signal of a third node, and control a signal of a fourth node; and a signal output module, configured to at least receive the signal of the fourth node, and control a gate driving signal, where: an enable level start time of the shift signal of each stage of shift register of the N stages of shift registers is shifted in sequence; and the shift signal output by an x-th stage shift register of the N stages of shift registers is the input signal received by a y-th stage shift register of the N stages of shift registers, where 1≤x≤N, 1≤y≤N, x≠y, and x, y and N each are positive integers; or the stage of shift register includes a shift control module, configured to at least receive an input signal, and control a signal of a first node and a signal of a second node; a shift output module, configured to at least receive the signal of the first node and the signal of the second node, and control a shift signal; an output control module, configured to at least receive a selection control signal and the shift signal, and control a signal of a fourth node; and a signal output module, configured to at least receive the signal of the fourth node and control output of a gate driving signal, where: in a display time of a frame, in the cascaded N-stage shift register, the stage of shift register that outputs the gate driving signal that includes an enable level is a third shift register; and in the third shift register, an enable level time of the gate driving signal is equal to an enable level time of the shift signal.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic structural diagram of a shift register;

FIG. 2 illustrates a driving timing diagram of a display panel;

FIG. 3 illustrates a schematic structural diagram of a display panel consistent with the disclosed embodiments of the present disclosure;

FIG. 4 illustrates a schematic structural diagram of a shift register consistent with the disclosed embodiments of the present disclosure;

FIG. 5 illustrates a driving timing diagram of a display panel consistent with the disclosed embodiments of the present disclosure;

FIG. 6 illustrates a schematic structural diagram of a pixel consistent with the disclosed embodiments of the present disclosure;

FIG. 7 illustrates a driving timing diagram of another display panel consistent with the disclosed embodiments of the present disclosure;

FIG. 8 illustrates a driving timing diagram of another display panel consistent with the disclosed embodiments of the present disclosure;

FIG. 9 illustrates a driving timing diagram of another display panel consistent with the disclosed embodiments of the present disclosure;

FIG. 10 illustrates a driving timing diagram of another display panel consistent with the disclosed embodiments of the present disclosure;

FIG. 11 illustrates a driving timing diagram of another display panel consistent with the disclosed embodiments of the present disclosure;

FIG. 12 illustrates a driving timing diagram of another display panel consistent with the disclosed embodiments of the present disclosure;

FIG. 13 illustrates a driving timing diagram of another display panel consistent with the disclosed embodiments of the present disclosure;

FIG. 14 illustrates a schematic structural diagram of another shift register consistent with the disclosed embodiments of the present disclosure;

FIG. 15 illustrates a schematic structural diagram of another shift register consistent with the disclosed embodiments of the present disclosure;

FIG. 16 illustrates a schematic structural diagram of another shift register consistent with the disclosed embodiments of the present disclosure;

FIG. 17 illustrates a schematic structural diagram of another shift register consistent with the disclosed embodiments of the present disclosure;

FIG. 18 illustrates a schematic structural diagram of another shift register consistent with the disclosed embodiments of the present disclosure;

FIG. 19 illustrates a driving timing diagram of a shift register consistent with the disclosed embodiments of the present disclosure;

FIG. 20 illustrates a driving timing diagram of another shift register consistent with the disclosed embodiments of the present disclosure;

FIG. 21 illustrates a schematic structural diagram of another shift register consistent with the disclosed embodiments of the present disclosure;

FIG. 22 illustrates a schematic structural diagram of another shift register consistent with the disclosed embodiments of the present disclosure;

FIG. 23 illustrates a schematic structural diagram of another shift register consistent with the disclosed embodiments of the present disclosure;

FIG. 24 illustrates a schematic structural diagram of another shift register consistent with the disclosed embodiments of the present disclosure; and

FIG. 25 illustrates a schematic structural diagram of a display device consistent with the disclosed embodiments of the present disclosure.

### DETAILED DESCRIPTION

To make the objectives, technical solutions and advantages of the present disclosure clearer and more explicit, the present disclosure is described in further detail with accompanying drawings and embodiments. It should be understood that the specific exemplary embodiments described herein are only for explaining the present disclosure and are not intended to limit the present disclosure.

Technologies, methods, and equipment known to those of ordinary skill in relevant fields may not be discussed in detail, but where appropriate, these technologies, methods, and equipment should be regarded as part of the present disclosure.

It should be noted that in the present disclosure, relational terms such as “first” and “second” are only used to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

Terms “connection” or “connected” and the like are not limited to physical or mechanical connections, and may include electrical connections, whether direct or indirect. Terms “over”, “below”, “left”, “right”, etc. are only used to indicate relative position relationships. When the absolute position of an object being described changes, the relative position relationships may also change accordingly. In addition, terms “same” and “equal” in the present disclosure do not mean that two objects are completely equal in size or shape. The two objects may be roughly same or roughly equal within a certain error range.

Reference will now be made in detail to embodiments of the present disclosure, which are illustrated in the accompanying drawings. Similar labels and letters designate similar items in the drawings. Once an item is defined in one drawing, the item may not be defined and discussed in subsequent drawings.

As described in Background, for a dynamic image with higher display quality requirements, the image refresh rate of the display panel may need to be higher. For a static image with lower display quality requirements, the image refresh rate of the display panel may be set to be lower to reduce the power consumption of the display panel. In existing technology, a driving circuit may be disposed in a display panel, and each stage of shift registers in the driving circuit may provide a gate driving signal for each row of pixels. As such, each pixel may be controlled to perform signal updating, and image refresh of the display panel may thus be realized.

When updating the signal in the pixel, it is necessary to provide the pixel with an enable level of the gate driving signal, to control the corresponding signal to be transmitted to the corresponding node of the pixel, thereby realizing signal updating. On the contrary, when there is no need to update the signal in the pixel, the enable level of the gate driving signal may not be provided to the pixel. That is, the gate driving signal received by the pixel may remain at a non-enable level. In this way, when the display screen of the display panel is refreshed in a partition, that is, in a part of the display frame of the display panel, only the signals in a part of the pixels are updated, while the signals in another part of the pixels do not need to be updated. In this case, the gate driving signal output by the shift register electrically connected to the pixel that needs to perform signal updating may include an enable level. The gate driving signal output by the shift register electrically connected to the pixel that does not need to perform signal updating may be kept at a non-enable level.

In existing technology, due to the structure of the shift register and the transition time of the selection control signal received by the shift register, when refreshing the display screen of the display panel in partitions, the shift registers at various levels of the driving circuit may not accurately output the gate driving signals.

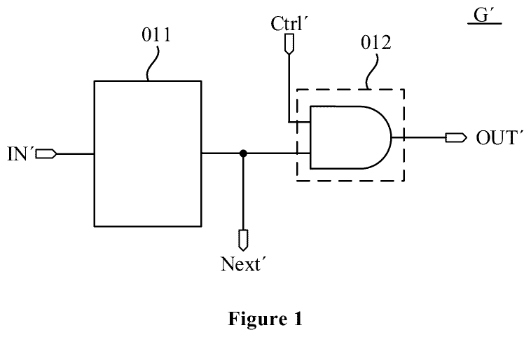

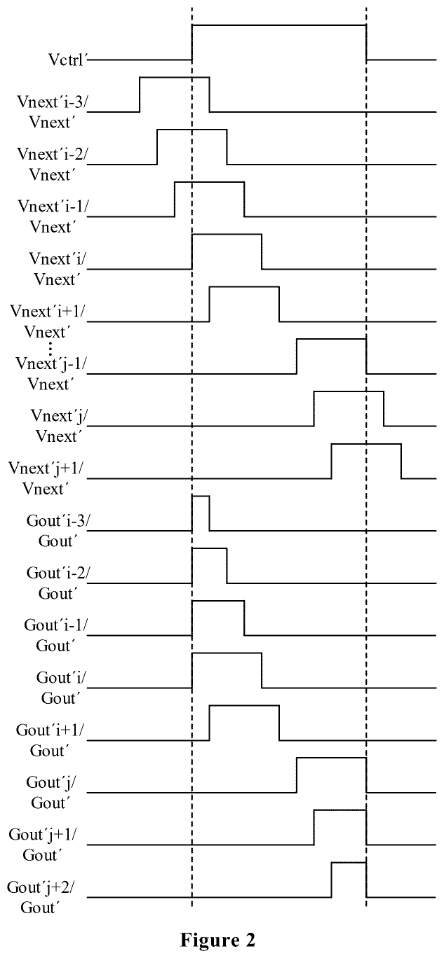

FIG. 1 illustrates a schematic structural diagram of a shift register in existing technology. FIG. 2 illustrates a driving timing diagram of a display panel in existing technology. As shown in FIGS. 1 and 2, in existing technology, a shift register G′ may include a shift module 011 and an output module 012. The shift module 011 may control the shift signal output terminal Next′ to output a shift signal Vnext′ under the control of the input signal received by the signal input terminal IN′. The output module 012 may control the driving signal output terminal OUT′ to output a gate driving signal Gout′ under the control of the shift signal Vnext′ output by the shift signal output terminal Next′ and the selection control signal Vctrl′ of the selection control signal terminal Ctrl′.

The output module 012 may include an AND gate. The two input terminals of the AND gate may be electrically connected to the shift signal output terminal Next′ and the selection control signal terminal Ctrl′ respectively. The output terminal of the AND gate may be electrically connected to the gate signal output terminal OUT'. When the shift signal Vnext′ output from the shift signal output terminal Next′ and the selection control signal Vctrl′ from the selection control signal terminal Ctrl′ each are at the enable level, the drive signal output terminal OUT′ may output the enable level of the gate driving signal Gout'. Otherwise, the driving signal output terminal OUT′ may output the non-enable level of the gate driving signal Gout′. As such, when the transition time of the selection control signal Vctrl′ of the selection control signal terminal Ctrl′ is within the enable level time of the shift signal Vnext′ output by a certain shift register G′, the enable level time of the gate driving signal Gout′ output by the shift register G′ may be incomplete. For example, when the time when the selection control signal Vctrl′ transits from the non-enable level to the enable level overlaps with the enable level time of the shift signal Vnext′i−3 output by the (i−3)-th stage shift register, the enable level time of the shift signal Vnext′i−2 output by the (i−2)-th stage shift register, and the enable level time of the shift signal Vnext′i−1 output by the (i−1)-th stage shift register, and the enable level time of the shift signal Vnext′i output by the i-th stage shift register, the enable level time of the shift signal Vnext′i+1 output by the (i+1)-th stage shift register, . . . , the enable level time of the shift signal Vnext′j−1 output by the (j−1)-th stage shift register are within the enable level time of the selection control signal Vctrl′, the enable level time of the gate driving signal Gout′i−3 output by the (i−3)-th stage shift register, the enable level time of the gate driving signal Gout′i−2 output by the (i−2)-th stage shift register, and the enable level time of the gate driving signal Gout′i−1 output by the (i−1)-th stage shift register each are shorter than the enable level time of the gate driving signal Gout′i output by the i-th stage shift register. That is, the enable level time of the gate driving signal Gout′i−3 output by the (i−3)-th stage shift register, the gate driving signal Gout′i−2 output by the (i−2)-th stage shift register, and the gate driving signal Gout′i−1 output by the (i−1)-th stage shift register is incomplete. The enable level time of the gate driving signal Gout′i output by the i-th stage shift register, the gate driving signal Gout′i+1 output by the (i+1)-th stage shift register, . . . , and the gate driving signal Gout′j−1 output by the (j−1)-th stage shift register is a complete enable level time. As such, the pixels electrically connected to the (i−3)-th stage shift register, the (i−2)-th stage shift register, and the (i−1)-th stage shift register may not accurately update the signal.

Similarly, when the time when the selection control signal Vctrl′ changes from the enable level to the non-enable level overlaps with the enable level time of the shift signal Vnext′j+1 output by the (j+1)-th stage shift register and the enable level time of the shift signal Vnext′j+2 output by the (j+2)-th stage shift register, the enable level time of the gate driving signal Gout′j+1 output by the (j+1)-th stage shift register and the enable level time of the gate driving signal Gout′j+2 output by the (j+2)-th stage shift register may be incomplete. As a result, the pixels electrically connected to the (j+1)-th stage shift register and the (j+2)-th stage shift register may not accurately perform signal updating.

To solve the above technical problems, the present disclosure provides a display panel. The display panel includes a driving circuit. The driving circuit includes a cascaded N-stage shift register. The shift register at least includes a shift control module, a shift output module, an output control module and a signal output module. At least under the control of the input signal and the selection control signal, the shift output module may accurately output the shift signal, and the signal output module may accurately output the gate driving signal, such that the shift signal may not be affected by the gate driving signal. Accordingly, while the signal transmission between different stages of the shift registers may be realized, the gate driving signal output by the shift register at each stage may be flexibly controlled. As such, the display panel may meet diversified display requirements, and the application scenarios of the display panel may be broadened.

In addition, in the shift register, the signal output module may output the gate driving signal at least under the control of the output control module. When the gate driving signal includes an enable level, the enable level time of the gate driving signal may be consistent with the enable level time of the shift signal. As such, the situation where the signal writing in the display panel is inaccurate due to the short enable level time of the gate driving signal output may be avoided. Accordingly, accurate display of the display panel may be realized, and the display effect of the display panel may be improved.

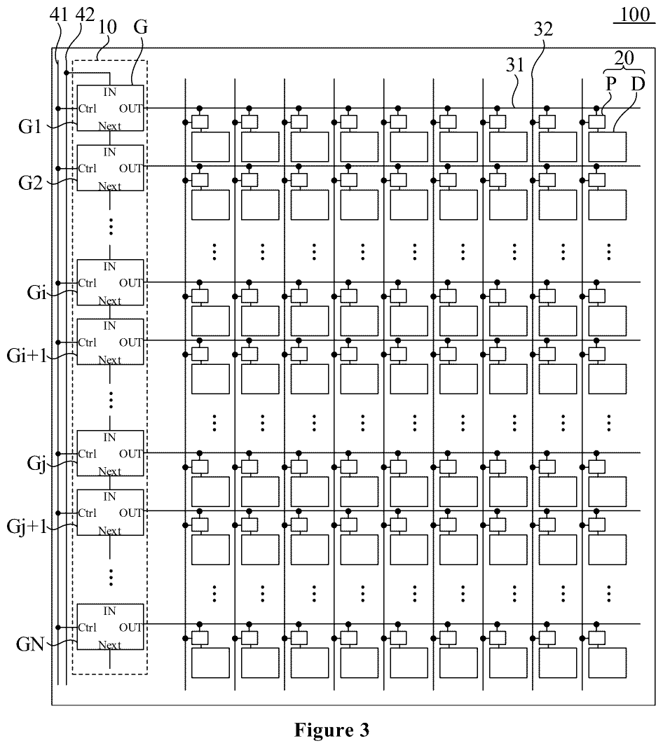

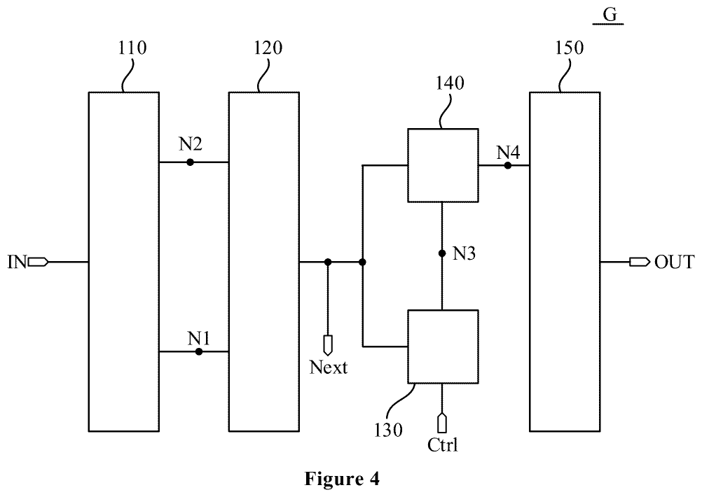

FIG. 3 illustrates a schematic structural diagram of a display panel consistent with the disclosed embodiments of the present disclosure. FIG. 4 illustrates a schematic structural diagram of a shift register consistent with the disclosed embodiments of the present disclosure. Referring to FIGS. 3 and 4, the display panel 100 includes a driving circuit 10. The driving circuit 10 includes a cascaded N-stage shift register G. The shift register G includes: a shift control module 110, configured to at least receive an input signal Vin and control a signal at a first node N1 and a signal at a second node N2; a shift output module 120, configured to at least receive a signal of the first node N1 and a signal of the second node N2, and control a shift signal Vnext; a selection control module 130, configured to at least receive the shift signal Vnext and the selection control signal Vctrl, and control the time for the selection control signal Vctrl to be transmitted to the third node N3 according to the shift signal Vnext; an output control module 140, configured to at least receive a shift signal Vnext and a signal of a third node N3, and control a signal of a fourth node N4; and a signal output module 150, configured to receive at least a signal of the fourth node N4 and control the gate driving signal Gout. The enable level start time of the shift signal Vnext of each stage of the shift register G may be shifted in sequence. The shift signal Vnextx output by the x-th stage shift register Gx is the input signal Viny received by the y-th stage shift register Gy, where 1≤x≤N, 1≤y≤N, x≠y, and x, y and N each are positive integers.

It may be understood that the shift register G may also include at least a signal input terminal IN, a shift signal output terminal Next, a selection signal terminal Ctrl, and a drive signal output terminal OUT. In this case, for a same shift register G, the shift control module 110 at least receives the input signal IN, and controls the signals of the first node N1 and the second node N2. The shift output module 120 may output a shift signal Vnext according to the signal of the first node N1 and the signal of the second node N2. The shift control module 110 may be electrically connected to the signal input terminal IN and the shift output module 120 respectively. The shift control module 110 and the shift output module 120 are electrically connected to the first node N1 and the second node N2 respectively. The shift output module 120 is also electrically connected to the shift signal output terminal Next.

The selection control module 130 receives at least a selection control signal Vctrl and the shift signal Vnext. That is, the selection control module 130 is at least electrically connected to the shift signal output terminal Next and the selection control signal terminal Ctrl, respectively. As such, the selection control module 130 may at least control the signal of the third node N3 according to the shift signal Vnext of the shift signal output terminal Next and the selection control signal Vctrl of the selection control signal terminal Ctrl. The output control module 140 receives at least the signal of the third node N3 and the shift signal Vnext. That is, the output control module 140 is at least electrically connected to the selection control module 130 and the shift signal output terminal Next, respectively. The output control module 140 and the selection control module 130 are electrically connected to the third node. As such, the output control module 140 may control the signal of the fourth node N4 according to at least the signal of the third node N3 and the shift signal Vnext of the shift signal output terminal Next. The signal output module 150 may at least receive a signal of the fourth node N4 and control the gate driving signal Gout. The signal output module 150 is at least electrically connected to the output control module 140 and the driving signal output terminal OUT respectively. The signal output module 150 and the output control module 140 are electrically connected to the fourth node N4.

Simultaneously, when the shift signal Vnextx output by the x-th stage shift register Gx is the input signal Viny received by the y-th stage shift register Gy, the x-th stage shift register Gx may be electrically connected to the y-th stage shift register Gy. Specifically, the shift signal output terminal Next for outputting the shift signal Vnextx in the x-th stage shift register Gx may be electrically connected to the signal input terminal IN for receiving the input signal Viny in the y-th stage shift register Gy. For example, when x=i, y may be equal to i+1. At this time, the shift signal output terminal Next of the i-th stage shift register Gi may be electrically connected to the signal input terminal IN of the (i+1)-th stage shift register Gi+1. As such, the (i+1)-th stage shift register Gi+1 may output the shift signal Vnexti+1 under the control of the shift signal Vnexti output by the i-th stage shift register Gi. Accordingly, the enable level start time of the shift signal Vnext output by each stage of the shift register G may be shifted in sequence, where i is a positive integer.

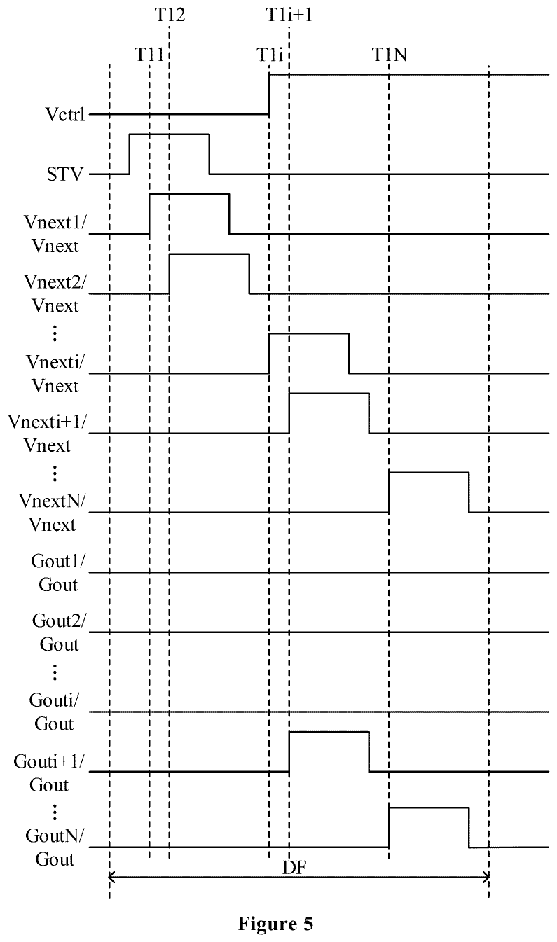

FIG. 5 illustrates a driving timing diagram of a display panel consistent with the disclosed embodiments of the present disclosure. Referring to FIGS. 3-5, the shift control module 110 of the first-stage shift register G1 may use the start control signal STV received by the signal input terminal IN as the input signal Vin1. As such, the shift control module 110 of the first-stage shift register G1 may control the signals of the first node N1 and the second node N2 according to the start control signal STV. Accordingly, the shift output module 120 of the first-stage shift register G1 may start to output the enable level of the shift signal Vnext1 at time T11 according to the signal of the first node N1 and the signal of the second node N2. The shift signal Vnext1 output by the first-stage shift register G1 may be used as the input signal Vin2 of the second-stage shift register G2. As such, the shift control module 110 of the second-stage shift register G2 may control the signal of the first node N1 and the signal of the second node N2 according to the shift signal Vnext1 output by the first-stage shift register G1. Accordingly, the shift output module 120 of the second-stage shift register G2 may start to output the enable level of the shift signal Vnext2 at time T12 according to the signal of the first node N1 and the signal of the second node N2.

By analogy, the i-th stage shift register Gi may start to output the enable level of the shift signal Vnexti at time T1i according to the input signal Vini the shift register receives. The (i+1)-th stage shift register Gi+1 may start to output the enable level of the shift signal Vnexti+1 at time T1i+1 according to the input signal Vini+1 the shift register receives. The N-th stage shift register GN may start to output the enable level of the shift signal VnextN at time T1N according to the input signal VinN the shift register receives. T12 is located after T11, T1i+1 is located after T11, T12, . . . , T1i, and T1N is located after 11, T12, . . . , T1i, T1i+1, . . , T1N−1. Accordingly, the enable level start time of the shift signal Vnext output by each stage of the shift register G may be shifted in sequence.

It should be noted that the enable level time of the shift signal Vnext output by each stage of the shift register G may be same or different, and may be designed according to actual needs. In one embodiment, as an example for illustrative description, the enable level time of the shift signal Vnext output by each stage of the shift register G is same. In this way, when the enable level start time of the shift signal Vnext output by each stage of the shift register G is shifted sequentially, the end time of the enable level of the shift signal Vnext output by each stage of the shift register G is also shifted sequentially.

In addition, the above only exemplarily shows the cascade of the shift registers at various levels when x is less than y, and x=i, y=i+1. In the present disclosure, the values of x and y may be designed according to actual needs. The present disclosure does not specifically limit the values of x and y provided that x is not equal to y.

Still referring to FIGS. 3-5, in the shift register G, the selection control module 130 may control the signal of the third node N3 according to the selection control signal Vctrl and the shift signal Vnext. For example, when the selection control signal Vctrl is at an enable level and the shift signal Vnext is at a non-enable level, the signal of the third node N3 may be controlled to be at an enable level. When the selection control signal Vctrl is at a non-enable level and/or the shift signal Vnext is at an enable level, the signal of the third node N3 may be controlled to be at a non-enable level or the signal written in the previous stage may be kept unchanged. That is, the signal of the third node N3 may be controlled by the selection control signal Vctrl and the shift signal Vnext simultaneously, and the time when the third node N3 changes to the enable level may be within the time when the shift signal Vnext is at the non-enable level. In this way, when the transition time of the selection control signal Vctrl overlaps with the enable level time of the shift signal Vnext of the shift register G, the signal of the third node N3 of the shift register G may be controlled to be maintained at an enable level or a non-enable level during the time when the shift signal Vnext is at the enable level. Accordingly, signal transition of the third node N3 during the period when the shift signal Vnext is at the enable level may be avoided, and the stability of the signal at the third node N3 may thus be improved.

Correspondingly, the output control module 140 may control the signal of the fourth node N4 provided to the signal output module 150 according to the signal of the third node N3 and the shift signal Vnext. As such, the signal output module 150 may output the corresponding gate driving signal Gout according to the signal of the fourth node N4. For example, when the signal at the third node N3 and the shift signal Vnext each are at an enable level, the signal of the fourth node N4 provided by the output control module 140 to the signal output module 150 may control the signal output module 150 to output the enable level of the gate driving signal Gout. When at least one of the signals at the third node N3 and the shift signal Vnext is at the non-enable level, the signal of the fourth node N4 provided by the output control module 140 to the signal output module 150 may control the signal output module 150 to output the non-enable level of the gate driving signal Gout. In this way, by controlling the signal of the third node N3 to remain unchanged when the shift signal Vnext is at the enable level, the enable level or the non-enable level of the gate driving signal Gout may be continuously output by the signal output module 150. As such, the output accuracy of the gate driving signal Gout may not be affected by the overlap of the transition time of the selection control signal Vctrl and the enable level time of the shift signal Vnext of the shift register G. Accordingly, when the gate driving signal output by the shift register G includes an enable level, the enable level time of the gate driving signal Gout output by the shift register G may be consistent with the enable level time of the shift signal Vnext. As a result, the accuracy of the gate driving signal Gout output by the shift register may be improved. In addition, when the gate driving signal output by the shift register is configured to control the signal update time in the display panel 100, by improving the accuracy of the gate driving signal Gout output by the shift register G, the accuracy of signal updating in the display panel 100 may be improved, and the display quality of the display panel 100 may thus be improved.

In addition, the shift signal Vnextx output by the x-th stage shift register Gx is used as the input signal Viny of the y-th stage shift register Gy. In a same shift register G, the shift signal Vnext and the gate driving signal Gout are provided by the shift output module 120 and the signal output module 150 respectively. As such, the shift signal Vnext may not be affected by the gate driving signal Gout. Thus, while the enable level start time of the shift signal Vnext output by each stage of the shift register G may be kept to be shifted in sequence, by controlling the selection control signal Vctrl received by each stage of the shift register G, the gate driving signal Gout output by each stage of the shift register G may be flexibly controlled. Accordingly, the gate driving signal Gout output by each stage of the shift register G may meet the diversified display requirements of the display panel 100.

It is understandable that when the display panel 100 may realize a diversified display, the display panel 100 may include a variety of display modules. The display panel may have different display brightness and/or refresh rate in different display modes. In this case, in different display modes, the enable level of the gate driving signal Gout output by each stage of the shift register G may be controlled to have different time durations and/or cycles; or, the number of display sub-areas included in the display panel may be different in different display modes, and the image refresh rate and/or display brightness of each display sub-area in a same mode may be different. At this time, in a same display mode, the gate driving signals output by the shift registers G electrically connected to the display sub-areas may be controlled to have different durations and/or periods of enable levels. In this way, by flexibly setting the enable level duration and/or cycle of the gate driving signal Gout output by each stage of the shift register G, the display requirements of the display panel in different display modes may be met.

In one embodiment, referring to FIG. 3, the display panel 100 may include a plurality of pixels 20 arranged in an array. The pixel 20 may include a pixel circuit P and a light-emitting element D. The pixel circuit P may provide a driving current to the light emitting element D according to the written data signal, to drive the light emitting element D to emit light. In this case, when the gate driving signal Gout output by the shift register G is configured to control the writing of the data signal of the pixel circuit P, by controlling the cycle of the enable level of the gate driving signal Gout output by the shift register G, the data refresh rate of the pixel circuit P may be controlled. As such, the image refresh rate of each display sub-area in the display panel may be controlled. When the gate driving signal Gout output by the shift register G is configured to control the duration of the pixel circuit P to provide the drive current to the light emitting element D, by controlling the duration of the enable level of the gate driving signal Gout output by the shift register G, the overall luminous brightness of the light-emitting element D may be controlled. Accordingly, the image display brightness of each display sub-area in the display panel 100 may be controlled.

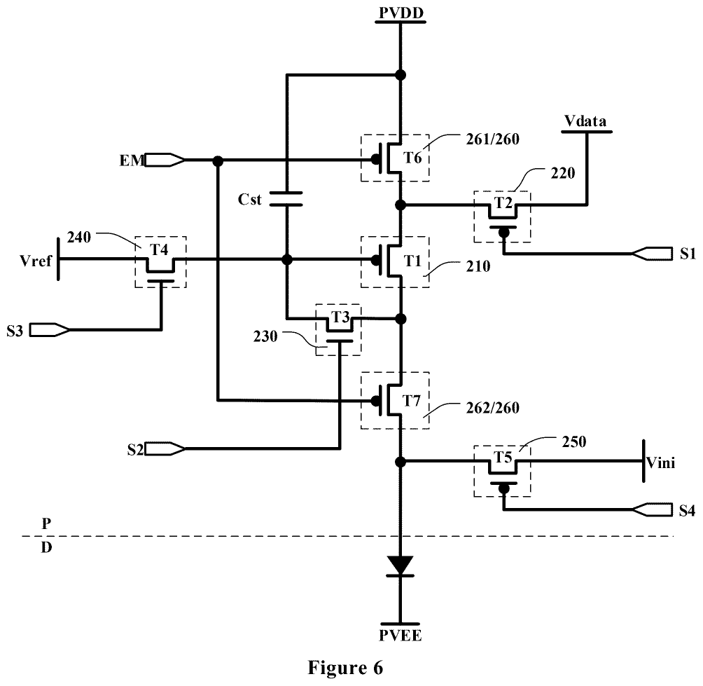

It should be noted that the structure of the pixel circuit P of each pixel 20 in the display panel 100 may be designed according to actual needs. The present disclosure does not limit a specific design. FIG. 6 illustrates a schematic structural diagram of a pixel consistent with the disclosed embodiments of the present disclosure. In one embodiment, as shown in FIG. 6, the pixel circuit P may include at least a compensation module 230, a data writing module 220, and a driving module 210. The driving module 210 includes a driving transistor T1. The data writing module 220 is configured to control the data signal Vdata to be written into the driving module 210. The compensation module 230 is configured to compensate the threshold voltage of the driving transistor T1 to the driving module 210. The driving module 210 is configured to selectively provide a driving current to the light emitting element D to control the display brightness of the light emitting element D.

In addition, the pixel circuit P may also include a reset module 240, an initialization module 250, and a light emitting control module 260. The reset module 240 is at least configured to provide a reset signal Vref to the gate of the driving transistor T1 to reset the gate of the driving transistor T1. The initialization module 250 is configured to provide an initialization signal Vini to the light emitting element D to initialize the light emitting element D. The light emitting control module 260 is configured to control the time of providing the driving current to the light emitting element D. Optionally, the light control module 260 may include a first light control module 261 and a second light control module 262. The first light emitting control module 261 is connected between the first power signal terminal and one electrode of the driving transistor T1. The second light emitting control module 262 is connected between the other electrode of the driving transistor T1 and one electrode of the light emitting element D.

The other electrode of the light emitting element D is electrically connected to the second power signal terminal.

The control terminal of the data writing module 220 receives a first scanning signal S1, and the first scanning signal S1 controls the opening and closing of the data writing module 220. The control terminal of the compensation module 230 receives a second scanning signal S2, and the second scanning signal S2 controls the opening and closing of the compensation module 230. The control terminal of the reset module 240 receives a third scanning signal S3, and the third scanning signal S3 controls the opening and closing of the reset module 240. The control terminal of the initialization module 250 receives a fourth scanning signal S4, and the fourth scanning signal S4 controls the opening and closing of the initialization module 250. The control terminal of the light emitting control module 260 receives a light emitting control signal EM, and the light emitting control signal EM controls the turning on and off of the light emitting control module 260.

In one embodiment, the data writing module 220 includes a data writing transistor T2, and the first scanning signal S1 may control the data writing transistor T2 to turn on and off. The compensation module 230 includes a compensation transistor T3, and the second scanning signal S2 may control the compensation transistor T3 to turn on and off. The reset module 240 includes a reset transistor T4, and the third scan signal S3 may control the reset transistor T4 to turn on and off. The initialization module 250 includes an initialization transistor T5, and the fourth scanning signal S4 may control the initialization transistor T5 to turn on and off. The first light emission control module 261 includes a first light emission control transistor T6. The second light emitting control module 262 includes a second light emitting control transistor T7. The light emission control signal EM may control the first light emission control transistor T6 and the second light emission control transistor T7 to turn on and off.

Optionally, the pixel circuit P may also include a storage capacitor Cst. The first terminal of the storage capacitor Cst is connected to the first power signal terminal. The second terminal is connected to the gate of the driving transistor T1 and is configured to store the gate signal of the driving transistor T1. As such, the driving transistor T1 may continuously provide the driving current in the light emitting stage, and the light emitting element D may emit light accurately.

It may be understood that the first power signal terminal may provide a first power signal PVDD, and the second power signal terminal may provide a second power signal PVEE. There is a potential difference between the first power signal PVDD and the second power signal PVEE, such that a driving current may be generated between the first power signal PVDD and the second power signal PVEE, to drive the light emitting element D to emit light for display.

It may also be understood that in the pixel circuit P, the types of the driving transistor T1, the data writing transistor T2, the compensation transistor T3, the reset transistor T4, the initialization transistor T5, the first light emission control transistor T6 and the second light emission control transistor T7 may be designed according to actual needs. The present disclosure does not limit a specific transistor type. In some embodiments, the reset transistor T4 and the compensation transistor T3 may be NMOS transistors. The driving transistor T1, the data writing transistor T2, the initialization transistor T5, the first light emission control transistor T6 and the second light emission control transistor T7 may each be PMOS transistors. In some other embodiments, the driving transistor T1, the data writing transistor T2, the compensation transistor T3, the reset transistor T4, the initialization transistor T5, the first light emission control transistor T6 and the second light emission control transistor T7 may each be PMOS transistors. For an NMOS transistor, the NMOS transistor is turned on when the signal received is at a high level, and the NMOS transistor is turned off when the signal received is at a low level. For a PMOS transistor, the PMOS transistor is turned on when the signal received by the gate is at a low level, and the PMOS transistor is turned off when the signal received by the gate is at a high level. In this way, when the type of each transistor is changed, the signal received by the gate of each transistor may be adjusted accordingly to achieve a same working timing.

It should be noted that FIG. 6 exemplarily shows the structure of a pixel circuit. However, the structure of the pixel circuit in the present disclosure is not limited thereto. Based on the pixel circuit provided in the present disclosure, the pixel circuit may include different quantities of corresponding transistors, and the present disclosure will not give examples one by one. For the convenience of description, without special limitation, the present disclosure will take the pixel circuit shown in FIG. 6 as an example to exemplarily illustrate the technical solution of the present disclosure.

As shown in FIG. 6, in one embodiment, the gate driving signal Gout output by the shift register G may control at least one of the data writing module 220, the compensation module 230, the reset module 240, the initialization module 250 and the light emitting control module 260 to be turned on or off. That is, the gate driving signal Gout output by the shift register G may be at least one of the first scanning signal S1, the second scanning signal S2, the third scanning signal S3, the fourth scanning signal S4 and the light emitting control signal EM. Provided that the core point of the present disclosure is achieved, the present disclosure does not make any specific limitation to the gate driving signal Gout.

The compensation module 230 and the initialization module 240 are each directly electrically connected to the gate of the driving transistor T1. When the gate driving signal Gout output by the shift register G controls the compensation module 230 or the initialization module 250 to be turned on or off, when the gate driving signal G output by the shift register G is at the enable level, the data signal written to the drive transistor T1 in a previous pixel cycle may be cleared. As such, the data signal of the current pixel cycle may be accurately written, and the signal refresh of the pixel circuit P may thus be realized. When the gate driving signal Gout output by the shift register G controls the conduction time of the light emitting control module 260, the duration of providing the driving current to the light emitting element D may be controlled. As such, the overall display luminous brightness of the light-emitting element D may be controlled.

In different modes, the display area of the display panel may include different display sub-areas. In a same display mode, when the display brightness of each display sub-area is different, the shift registers electrically connected to the pixel circuits of different display sub-areas may be controlled to output gate driving signals with different enable level durations. In a same display mode, when the refresh rates of the display sub-areas are different, the shift registers electrically connected to the pixel circuits of different display sub-areas may be controlled to output enable levels with different rates.

In the present disclosure, for convenience of description, without any special limitation, in different display modes, the display panel may include different numbers of display sub-areas. In a same display mode, the refresh rates of the display sub-areas may be different.

Still referring to FIGS. 3-5, the display panel 100 may also include a plurality of signal lines. Each signal line may be used to transmit a corresponding signal to control the pixel 20 and the driving circuit 10 in the display panel 100 for operation. For example, a plurality of gate driving signal lines 31 and a plurality of data signal lines 32 may be disposed in the display area of the display panel 100. At least part of the pixels 20 located in a same row may be electrically connected to a same gate driving signal line 31, and at least part of the pixels 20 located in a same column may be electrically connected to a same data signal line. As such, the gate driving signal Gout output by the drive circuit transmitted by the gate driving signal line 32 may control the writing time of the data signal on each data signal line 31 to each pixel 20. Accordingly, row-by-row scanning of each row of pixels in the display panel 100 may be achieved.

Still referring to FIGS. 3-5, when the first-stage shift register G1 is located at the far end of the driving chip providing the start control signal, the display panel 100 may also include a start signal transmission line 42. The start signal transmission line 42 may transmit the start control signal STV to the first stage shift register G1, such that the first stage shift register G1 may start working normally. The shift signal Vnext1 may be provided to the second-stage shift register G2. As such, the signal level transmission requirements of each stage of shift register G may be met, and the driving circuit may operate normally.

Still referring to FIGS. 3-5, the display panel 100 may also include a selection signal transmission line 41. The selection signal transmission line 41 may be used to transmit the selection control signal Vctrl. The selection control module 130 of each stage of the shift register G is electrically connected to the selection signal transmission line 41. The time at which the selection control module 130 of each stage of the shift register G transmits the selection control signal Vctrl to the third node N3 may be shifted sequentially.

When the selection control module 130 of the shift registers G at each level is electrically connected to a same gating signal transmission line 41, the shift registers G at each level may receive a same selection control signal Vctrl. In this case, the time when the selection control module 130 of each stage of the shift register G transmits the selection control signal Vctrl to the third node N3 may be shifted in sequence. As such, the time when the selection control signal is written into the third node N3 of each stage of the shift register G may be independent of each other, without overlapping. Accordingly, the switching of the selection control signal Vctrl may not affect the stability of the signal at the third node N3 in each stage of the shift register G during the period when the output shift signal Vnext is at the enable level. As a result, when the output control module 140 of the shift register G provides the signal of the fourth node N4 to the signal output module 150 according to the signal of the third node N3 and the shift signal Vnext, the signal of the fourth node N4 may control the signal output module 150 to accurately output the gate driving signal Gout.

Still referring to FIGS. 3-5, the display mode of the display panel 100 may include a first mode. In the first mode, the selection control signal Vctrl may include an enable level and a non-enable level.

In a same shift register, the selection control signal Vctrl received by the selection control module 130 may become the enable level before the shift output module 120 outputs the enable level of the shift signal Vnext. Then, the selection control module 130 may control the signal of the third node N3 to maintain the enable level according to the selection control signal Vctrl and the shift signal Vnext. As such, when the shift signal Vnext becomes the enable level, the output control module 140 may provide the signal of the fourth node N4 to the signal output module 150 according to the enable level of the shift signal Vnext and the enable level of the third node N3. The signal of the fourth node N4 may control the signal output module 150 to output the enable level of the gate driving signal Gout.

On the contrary, when the selection control signal Vctrl received by the selection control module 130 becomes a non-enable level before the shift output module 120 outputs the enable level of the shift signal Vnext, the selection control module 130 may control the signal of the third node N3 to remain at a non-enable level according to the selection control signal Vctrl and the shift signal Vnext. As such, when the shift signal Vnext becomes the enable level, the output control module 140 may provide the signal of the fourth node N4 to the signal output module 150 according to the enable level of the shift signal Vnext and the non-enable level of the third node N3. The signal at the fourth node N4 may control the gate driving signal Gout output by the signal output module 150 to remain at a non-enable level.

When each stage of shift register G receives a same selection control signal Vctrl, within the one-frame display time DF in the first mode, when the selection control signal Vctrl includes an enable level and a non-enable level, the selection control signal Vctrl may change between the enable level and the non-enable level. As such, the shift register G of each level of the driving circuit 10 may include a first type shift register and a second type shift register. The time when the selection control signal Vctrl changes to the enable level may be before the enable level time of the shift signal Vnext of the first type shift register, such that the gate driving signal Gout output by the first type shift register may include an enable level. The time when the selection control signal Vctrl changes to the non-enable level may be before the enable level time of the shift signal Vnext of the second type shift register. As such, the gate driving signal Gout output by the second type shift register may continue to be maintained at a non-enable level. At this time, in the first mode, the display sub-area where each pixel 20 electrically connected to the first type shift register is located may be controlled to have a higher data refresh rate. The display sub-areas where the rows of pixels 20 electrically connected to the second type shift registers are located may have a lower data refresh rate. Accordingly, partition refresh of the display panel may be achieved. As a result, diversified display requirements of the display panel may be met, and low power consumption and high display quality of the display panel may be achieved.

In one embodiment, as an example, in the first mode, the display panel includes two display sub-areas. Referring to FIGS. 3-5, in one frame display time DF of the first mode, the display sub-areas to which the rows of pixels 20 electrically connected to the first-stage shift register G1 to the i-th-stage shift register Gi belong may not refresh the data signal, and the display sub-areas to which the rows of pixels 20 electrically connected to the (i+1)-th-stage shift register Gi+1 to the N-th-stage shift register GN belong may need to refresh the data signal. In this case, before the shift signal Vnext1 output by the first-stage shift register G1 reaches the enable level, the selection control signal Vctrl may be controlled to change to be a non-enable level, and before the shift signal Vnexti output by the i-th stage shift register Gi changes to the enable level, the selection control signal Vctrl may be controlled to continue to be at the non-enable level. As such, the signal of the third node N3 of each shift register G (G1, G2, . . . , Gi) in the first-stage shift register G1 to the i-th-stage shift register Gi may be kept at a non-enable level. Accordingly, when the output control module 140 of each shift register G (G1, G2, . . . , Gi) in the first-stage shift register G1 to the i-th-stage shift register Gi provides the signal of the fourth node N4 to the signal output module 150 thereof according to the signal of the third node N3 thereof and the shift signal Vnext (Vnext1, Vnext2, . . . , Vnexti), the signal output module 150 of each shift register G (G1, G2, . . . , Gi) from the first-stage shift register G1 to the i-th-stage shift register Gi may continuously output the non-enable level of the gate driving signal Gout (Gout1, Gout2, . . . , Gouti) according to the signal of the fourth node N4 thereof. As a result, the pixels 20 in each row electrically connected to each shift register G (G1, G2, . . . , Gi) from the first-stage shift register G1 to the i-th-stage shift register Gi may not be refreshed. That is, the display image of the display sub-area where the part of pixels 20 are located may not be refreshed.

Before the (i+1)-th stage shift register Gi+1 outputs the enable level of the shift signal Vnexti+1, the selection control signal Vctrl received by the (i+1)-th stage shift register Gi+1 may be controlled to become the enable level. Before the N-th stage shift register GN outputs the enable level of the shift signal VnextN, the selection control signal Vctrl may be continuously maintained at the enable level. As such, the signal of the third node N3 of each shift register G (Gi+1, . . . , GN) in the (i+1)-th stage shift register Gi+1 to the N-th stage shift register GN may be kept at the enable level. As a result, when the output control module 140 of each shift register G (Gi+1, . . . , GN) in the (i+1)-th stage shift register Gi+1 to the N-th stage shift register GN provides the signal of the fourth node N4 to the signal output module 150 thereof according to the signal of the third node N3 and the shift signal Vnext (Vnexti+1, . . . , VnextN), the signal output module 150 of each shift register G (Gi+1, . . . , GN) in the (i+1)-th stage shift register Gi+1 to the N-th stage shift register GN may output the gate driving signal Gout (Gouti+1, . . . , GoutN), according to the signal of the fourth node N4 thereof. The gate driving signal Gout may include an enable level, and the enable level start time may shift sequentially. As such, the pixels 20 in each row electrically connected to the shift registers G (Gi+1, . . . , GN) of the (i+1)-th stage shift register Gi+1 to the Nth stage shift register GN may be refreshed in sequence. That is, the display image of the display sub-area where the part of pixels 20 are located may be refreshed. In this way, by controlling the change of the selection control signal Vctrl between the enable level and the non-enable level, each stage of the shift register G may accurately output the gate driving signal Gout, and partition refresh of the display panel 100 may be realized. Accordingly, while reducing the display power consumption of the display panel 100, the display quality of the display panel 100 may be improved.

It should be noted that FIG. 5 only exemplarily shows that in the first mode, when the display panel includes two display sub-areas with different refresh rates, the shift signal Vnext and the gate driving signal Gout output by each shift register may change with the selection control signal Vctrl. As shown in FIG. 5, in a display time DF of a frame of image, the enable level start time of the shift signal of each shift register that outputs the gate driving signal Gout including the enable level is located after the enable level start time of the shift signal of the shift register whose gate driving signal is at the non-enable level. Thus, within the display time DF of the frame of image, the selection control signal Vctrl may transit from the non-enable level to the enable level for one time. In one embodiment, when the display mode of the display panel is the first mode, under the premise that the selection control signal includes the enable level and the non-enable level, the number of transitions and the transition mode of the selection control signal in one frame, as well as the number of display sub-areas with different refresh rates in the display panel may be designed according to actual needs. The present disclosure does not specifically limit a specific design.

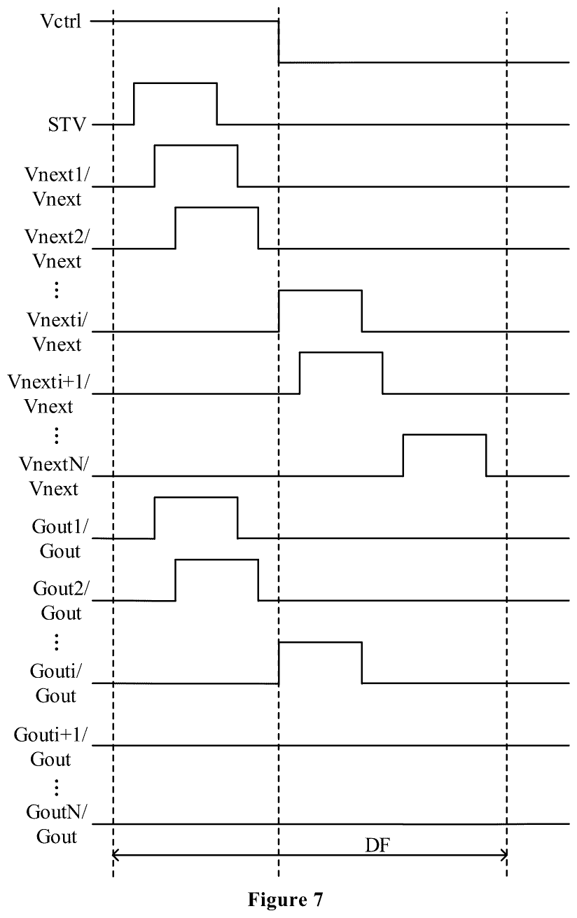

FIG. 7 illustrates a driving timing diagram of another display panel consistent with the disclosed embodiments of the present disclosure. In one embodiment, as shown in FIG. 7, in the display time DF of a frame of image, the enable level start time of the shift signal Vnext of each shift register outputing the gate driving signal Gout including the enable level is before the enable level start time of the shift signal Vnext of the shift register whose gate driving signal Gout is at the non-enable level. That is, while each of the shift registers from the first stage to the i-th stage outputs the enable level of the shift signal Vnext (Vnext1, Vnext2, . . . , Vnexti), the output gate driving signal Gout (Gout1, Gout2, . . . , Gouti) may be output. The enable level start time of the shift signal Vnext (Vnexti+1, . . . , VnextN) output by each shift register from the (i+1)-th stage shift register Gi+1 to the N-th stage shift register GN may be shifted in sequence, and the output gate driving signal Gout (Goutj+1, . . . , GoutN) may still be kept at the non-enable level. Accordingly, within the display time DF of the frame, the selection control signal Vctrl may transit from the non-enable level to the enable level for one time.

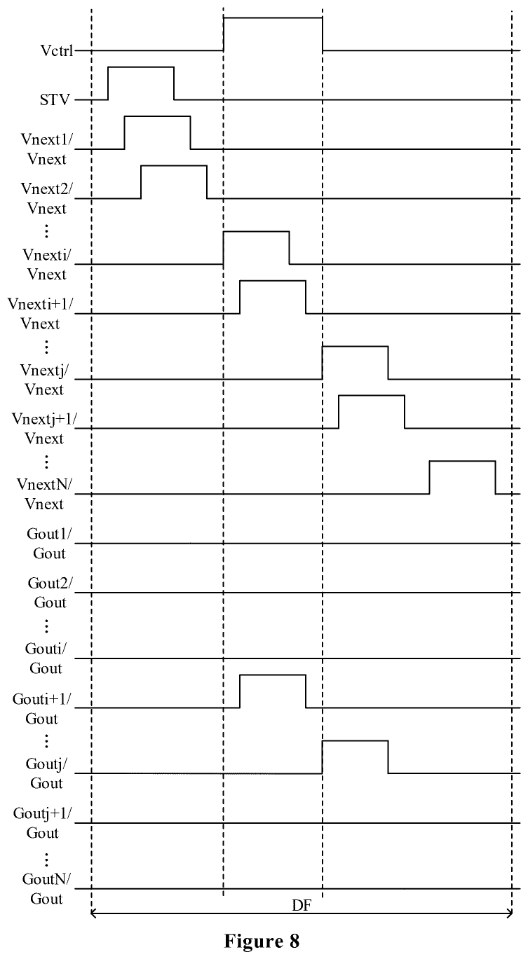

FIG. 8 illustrates a driving timing diagram of another display panel consistent with the disclosed embodiments of the present disclosure. In another embodiment, as shown in FIG. 8, in the display time DF of a frame, the enable level start time of the shift signal Vnext (Vnext1, Vnext2, . . . , Vnexti) output by each shift register from the first stage to the i-th stage shift register may be shifted in sequence. The output gate driving signal Gout (Gout1, Gout2, . . . , Gouti) may be continuously kept at a non-enable level. Each shift register from the (i+1)-th stage shift register to the j-th stage shift register may output the enable level of the shift signal Vnext (Vnexti+1, . . . , Vnextj), and may simultaneously output the enable level of the gate driving signal Gout (Gouti+1, . . . , Goutj). Accordingly, the enable level start time of the gate driving signal Gout (Gouti+1, . . . , Goutj) output by the (i+1)-th stage shift register to the j-th stage shift register may be shifted in sequence. The enable level start time of the shift signal Vnext (Vnextj+1, . . . , VnextN) output from the (j+1)-th stage shift register to the N-th stage shift register may be shifted in sequence, and the output gate driving signal Gout (Goutj+1, . . . , GoutN) may be continuously kept at the non-enable level. Accordingly, within the display time DF of the frame, the selection control signal Vctrl may transit from the non-enable level to the enable level for one time, and from the non-enable level to the enable level for one time.

It may be understood that the above description is merely an exemplary description of the transition of the selection control signal between the enable level and the non-enable level within the display time of a same frame in the first mode. In one embodiment, when the display panel is in the first mode, the display panel may include the display time of a plurality of frames. In the display time of each frame, the transition situation of the selection control signal may be same or different, and may be designed according to actual needs, which is not specifically limited by the present disclosure.

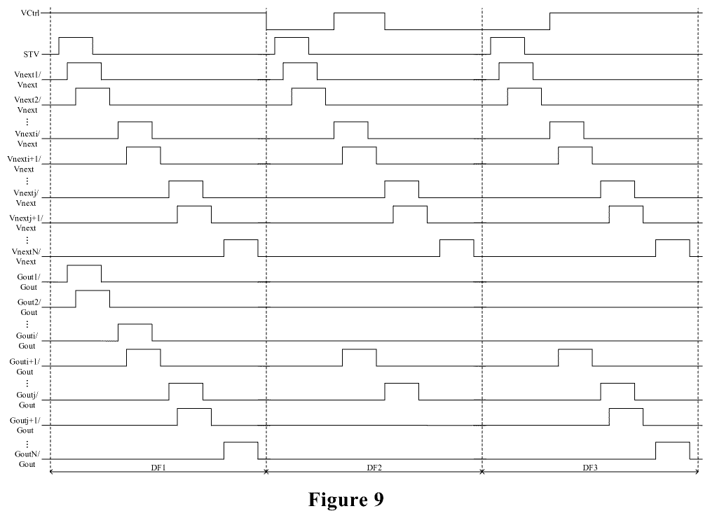

FIG. 9 illustrates a driving timing diagram of another display panel consistent with the disclosed embodiments of the present disclosure. In one embodiment, as shown in FIG. 9, in the first mode, the display panel 100 may include a plurality of image display cycles. Each image display cycle may include a display time of three frames of images. In an image display cycle, during the display time DF1 of the first frame, while each stage of shift register is be controlled to output the enable level of the shift signal Vnext (Vnext1, Vnext2, . . . , Vnexti, Vnexti+1, . . . , Vnextj, Vnextj+1, . . . , VnextN), the enable level of the gate driving signal Gout (Gout1, Gout2, . . . , Gouti, Gouti+1, . . . , Goutj, Goutj+1, . . . , GoutN) may be output. As such, in the display time DF1 of the first frame, the selection control signal Vctrl may continue to maintain the enable level. That is, during the display time DF1 of the first frame, the selection control signal Vctrl may not transit. As a result, data may be refreshed for each row of pixels in the display panel.

During the display time DF2 of the second frame, each stage of shift register may be controlled to output a shift signal Vnext (Vnext1, Vnext2, . . . , Vnexti, Vnexti+1, . . . , Vnextj, Vnextj+1, . . . , VnextN) whose enable level is shifted in sequence. While each stage of shift register in the (i+1)-th stage shift register to the j-th stage shift register outputs the enable level of the shift signal Vnext (Vnexti+1, . . . , Vnextj), each stage of shift register in the (i+1)-th stage shift register to the j-th stage shift register may output the gate driving signal Gout (Gouti+1, . . . , Goutj) whose enable level start time is shifted in sequence. The gate driving signals Gout (Gout1, Gout2, . . . , Gouti) of the shift registers from the first stage to the i-th stage, and the gate driving signals Gout (Goutj+1, . . . , GoutN) of the shift registers from the (j+1)-th stage to the N-th stage may continue to be kept at the non-enabled level. As such, in the display time DF2 of the second frame, the selection control signal Vctrl may first be kept at the non-enable level, transit from the non-enable level to the enable level, and then transit from the enable level to the non-enable level. That is, during the display time DF2 of the second frame, the selection control signal Vctrl may transit twice. Accordingly, during the display time of the second frame, only the rows of pixels electrically connected to the shift registers of the (i+1)-th to j-th stages may be refreshed, while other pixels may not be refreshed.

During the display time DF3 of the third frame, each stage of shift register may be controlled to output the shift signal Vnext (Vnext1, Vnext2, . . . , Vnexti, Vnexti+1, . . . , Vnextj, Vnextj+1, . . . , VnextN) whose enable level is shifted in sequence. While each stage of shift register in the (i+1)-th stage shift register to the N-th stage shift register outputs the enable level of the shift signal Vnext (Vnexti+1, . . . , Vnextj, . . . , VnextN), each stage of shift register in the (i+1)-th stage shift register to the N-th stage shift register may output a gate driving signal Gout (Gouti+1, . . . , Goutj, . . . , GoutN) whose enable level start time is shifted in sequence. The gate driving signals Gout (Gout1, Gout2, . . . , Gouti) of the shift registers from the first stage to the i-th stage may continue to be kept at the non-enable level. As such, in the display time DF3 of the third frame, the selection control signal Vctrl may be first kept at the non-enable level, and then transit from the non-enable level to the enable level. That is, during the display time DF3 of the third frame, the selection control signal Vctrl may transit for one time. Accordingly, during the display time of the second frame, the data of each row of pixels electrically connected to each shift register from the (i+1)-th stage shift register to the N-th stage shift register may be refreshed. However, data refresh may not be performed on the rows of pixels electrically connected to the first-stage shift register to the i-th stage shift register.

In one embodiment, the display sub-area where the pixels electrically connected to the shift registers from the first stage to the i-th stage are located is the first display sub-area; the display sub-area where the pixels electrically connected to the shift registers from the (i+1)-th stage to the j-th stage are located is the second display sub-area; and the display sub-region where the pixels electrically connected to each shift register from the (j+1)-th stage shift register to the N-th stage shift register are located is the third display sub-region. The refresh rate of the second display sub-region may be greater than the refresh rate of the third display sub-region. The refresh rate of the third display sub-area may be greater than the refresh rate of the first display sub-area. As such, the display panel may include three display sub-areas with different refresh rates.

FIG. 9 only exemplarily illustrates the case where the display mode of the display panel is the first mode, and one image display cycle of the display panel includes the display time of three frames. In one embodiment, the number of frames whose display time is included in each image display cycle of the display panel may be two or more. The number of frames may be specifically designed according to actual needs, and is not specifically limited in the present disclosure.

It may be understood that the above description is only an exemplary description of the transition time of the selection control signal and the enable level time of the shift signal output by each stage of the shift register. Provided that each stage of shift register may accurately output the gate driving signal, the present disclosure does not specifically limit the transition time of the selection control signal.

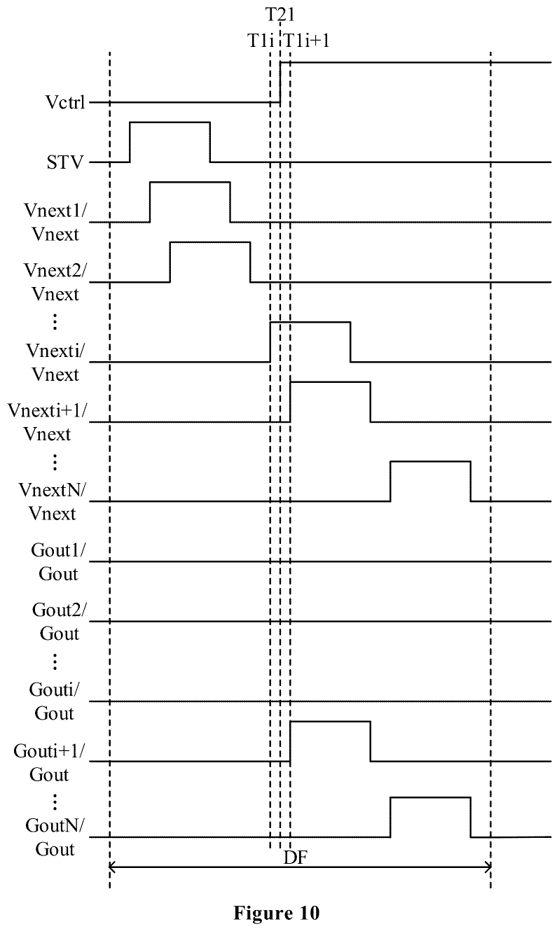

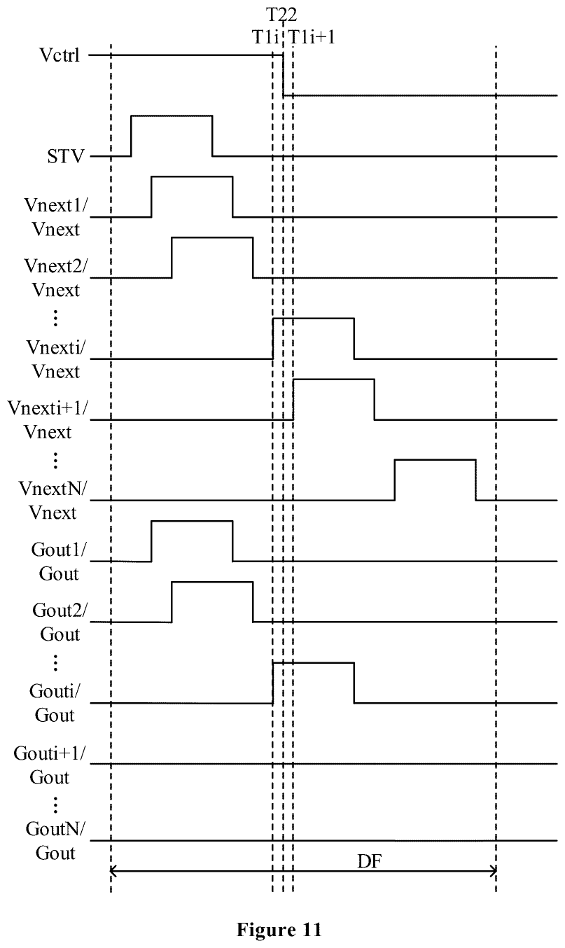

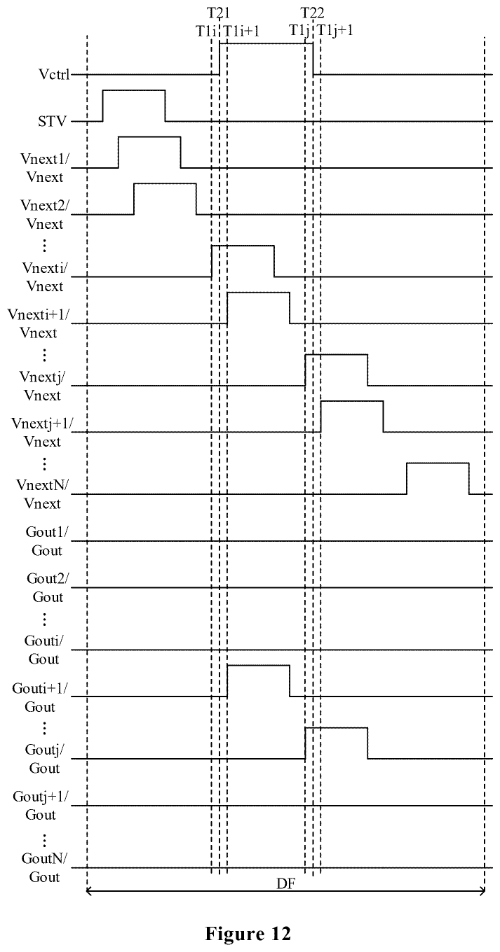

FIG. 10 illustrates a driving timing diagram of another display panel consistent with the disclosed embodiments of the present disclosure. FIG. 11 illustrates a driving timing diagram of another display panel consistent with the disclosed embodiments of the present disclosure. FIG. 12 illustrates a driving timing diagram of another display panel consistent with the disclosed embodiments of the present disclosure. In one embodiment, referring to FIGS. 3, and 10-12, in the first mode, the cascaded N-stage shift register G includes a first shift register and/or a second shift register. The time T21 when the selection control signal Vctrl transits from the non-enable level to the enable level is between the enable level start time of the input signal Vin of the first shift register and the enable level start time of the shift signal Vnext. The time when the selection control signal Vctrl transits from the enable level to the non-enable level is between the enable level start time of the input signal Vin of the second shift register and the enable level start time of the shift signal Vnext.

Since the shift signal Vnextx output by the x-th stage shift register Gx is used as the input signal Viny of the y-th stage shift register Gy, the time T21 when the selection control signal Vctrl transits from the non-enable level to the enable level may be located between the enable level start time of the shift signal output by the shift register that provides the input signal Vin to the first shift register and the enable level start time of the shift signal Vnext of the first shift register. The time T22 when the selection control signal Vctrl transits from the enable level to the non-enable level may be located between the enable level start time of the shift signal output by the shift register that provides the input signal Vin to the second shift register and the enable level start time of the shift signal Vnext of the second shift register.

In one embodiment, referring to FIGS. 3 and 10, taking y=x+1 as an example, the cascaded N-stage shift register G may include the first shift register, and the pixel 20 electrically connected to the i-th stage shift register Gi may be the boundary pixel of the low refresh rate display sub-area where the pixel 20 is located. When the pixel 20 electrically connected to the (i+1)-th stage shift register Gi+1 is a boundary pixel of the high refresh rate display sub-area where the pixel 20 is located, the (i+1)-th stage shift register may be the first shift register. In this case, the time T21 when the selection control signal Vctrl transits from the non-enable level to the enable level may be set to be located between the enable level start time T1i of the shift signal Vnexti of the i-th stage shift register Gi and the enable level start time T1i+1 of the (i+1)-th stage shift register Gi+1. That is, the time T21 when the selection control signal Vctrl changes from the non-enable level to the enable level may be located after the enable level start time T1i of the shift signal Vnexti of the i-th stage shift register Gi.

As such, the signal written into the third node N3 in the first-stage shift register G1 to the i-stage shift register Gi through the selection control module of each stage shift register G in the first-stage shift register G1 to the i-th stage shift register Gi may be at a non-enable level. Accordingly, each shift register G from the first-stage shift register G1 to the i-th stage shift register Gi may output a gate driving signal Gout (Gout1, Gout2, . . . , Gouti) that is continuously maintained at a non-enable level. Simultaneously, the time T21 when the selection control signal Vctrl transits from the non-enable level to the enable level is located before the enable level start time T1i+1 of the shift signal Vnexti+1 of the (i+1)-th stage shift register Gi+1. As such, before the shift signal Vnexti+1 of the (i+1)-th stage shift register Gi+1 transits to the enable level, the selection control module of the (i+1)-th stage shift register Gi+1 may control the signal of the third node N3 to be at the enable level. Accordingly, when the shift signal Vnexti of the (i+1)-th stage shift register Gi+1 changes to the enable level, the enable level of the gate driving signal Gouti+1 output by the (i+1)-th stage shift register Gi+1 may be controlled. In this way, the requirements of partition refresh of the display panel may be met, and each shift register may accurately output the gate driving signal. Accordingly, the display refresh accuracy of the display panel may be improved, and the display quality of the display panel may be improved.

In another embodiment, referring to FIGS. 3 and 11, taking y=x+1 as an example, the cascaded N-stage shift register G includes a second shift register, and the pixel 20 electrically connected to the i-th stage shift register Gi may be a boundary pixel of the high refresh rate display sub-area where the pixel 20 is located. When the pixel 20 electrically connected to the (i+1)-th stage shift register Gi+1 is a boundary pixel of the display sub-area with a low refresh rate where the pixel 20 is located, the (i+1)-th stage shift register may be a second shift register. In this case, the time T22 when the selection control signal Vctrl transits from the enable level to the non-enable level may be set to be located between the enable level start time T1i of the shift signal Vnexti of the i-th stage shift register Gi and the enable level start time T1i+1 of the (i+1)-th stage shift register Gi+1. That is, the time T22 when the selection control signal Vctrl changes from the enable level to the non-enable level may be located after the enable level start time T1i of the shift signal Vnexti of the i-th stage shift register Gi. As such, the signal written into the third node N3 in the first-stage shift register G1 to the i-th stage shift register Gi through the selection control module of each stage shift register G in the first-stage shift register G1 to the i-th-stage shift register Gi may be at an enable level. As a result, each shift register G from the first-stage shift register G1 to the i-th stage shift register Gi may output the gate driving signal Gout (Gout1, Gout2, . . . , Gouti) whose enable level start time may be shifted in sequence.

Simultaneously, the time T22 when the selection control signal Vctrl changes from the enable level to the non-enable level may be located before the enable level start time T1i+1 of the shift signal Vnexti+1 of the (i+1)-th stage shift register Gi+1. As such, before the shift signal Vnexti+1 of the (i+1)-th stage shift register Gi+1 transits to the enable level, the selection control module of the (i+1)-th stage shift register Gi+1 may control the signal of the third node N3 to be at the non-enable level. Thus, when the shift signal Vnexti of the (i+1)-th stage shift register Gi+1 changes to the enable level, the (i+1)-th stage shift register Gi+1 may maintain the non-enable level of the output gate driving signal Gouti+1. In this way, the requirements of partition refresh of the display panel may be met, and each shift register may accurately output a gate driving signal. Accordingly, the display refresh accuracy of the display panel may be improved, and the display quality of the display panel may be improved.

In another embodiment, referring to FIGS. 3 and 12, the cascaded N-stage shift register G may include a first shift register and a second shift register simultaneously. For example, the (i+1)-th stage shift register Gi+1 may be a first shift register, and the (j+1)-th stage shift register Gj may be a second shift register. In this case, the time T21 when the selection control signal Vctrl transits from the non-enable level to the enable level is between the enable level start time T1i of the shift signal Vnexti of the i-th stage shift register Gi and the enable level start time T1i+1 of the (i+1)-th stage shift register Gi+1. The time T22 when the selection control signal Vctrl transits from the enable level to the non-enable level is between the enable level start time T1j of the shift signal Vnexti of the j-th stage shift register Gj and the enable level start time T1j+1 of the (j+1)-th stage shift register Gj+1. In this way, the display panel 100 may include two display sub-areas with a lower refresh rate and one display sub-area with a higher refresh rate. The display sub-area with a higher refresh rate may be between the display sub-areas with a lower refresh rate.

As such, setting the time when the selection control signal transits from the non-enable level to the enable level between the enable level start time of the input signal of the first shift register and the enable level start time of the shift signal, may at least realize that the gate driving signal output by the first shift register includes the enable level. Setting the time when the selection control signal transits from the enable level to the non-enable level between the enable level start time of the input signal of the second shift register and the enable level start time of the shift signal may at least realize that the gate driving signal output by the second shift register is at the non-enable level. Simultaneously, for a same shift register, there is a certain interval between the enable level start time of the input signal and the enable level start time of the shift signal. As such, by setting the transition time of the selection control signal between the enable level start time of the input signal and the enable level start time of the shift signal of the same shift register, sufficient time may be reserved for the rising edge or falling edge when the selection control signal changes. Accordingly, the selection control signal may be set in a flexible way, the driver program of the driving chip that provides the selection control signal and other control signals to the display panel may be simplified, and the driving cost of the display panel may be reduced.

The above description is merely an exemplary description of the change of the selection control of the display panel in the first mode and the gate driving signals output by the shift registers at each stage. In one embodiment, the display panel may include a plurality of display modes. The changes in the selection control in each display mode and the gate driving signals output by each stage of shift register may be designed according to actual needs, which will not be limited by the present disclosure.

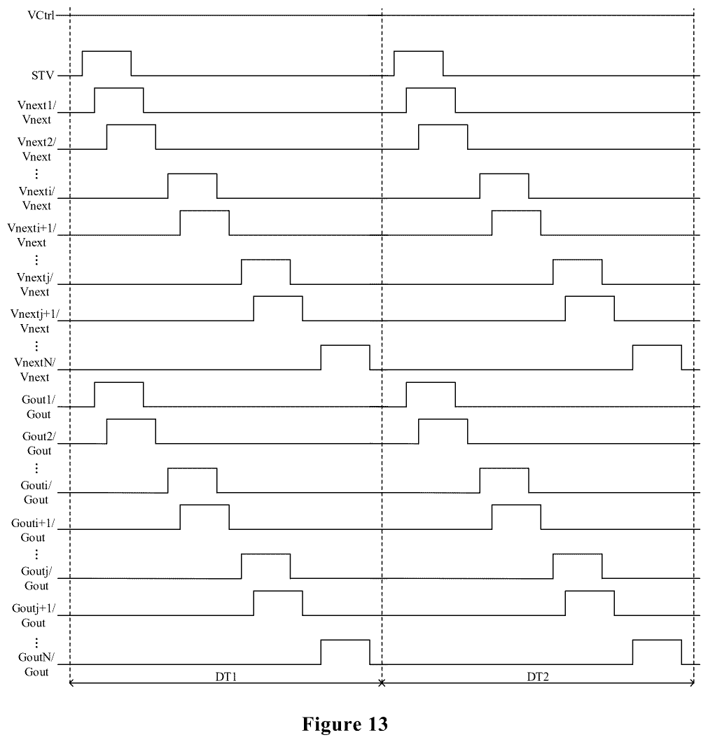

FIG. 13 illustrates a driving timing diagram of another display panel consistent with the disclosed embodiments of the present disclosure. Referring to FIGS. 3, 4 and 13, the display mode of the display panel 100 may also include a second mode. In the second mode, the selection control signal Vctrl may be at an enable level.

In the second mode, when the selection control signal Vctrl continues to be at the enable level, during the display time DT1 (DT2) of a frame, the signal at the third node N3 of each stage of the shift register G may be continuously maintained at the enable level. As such, each stage of shift register G may output the enable level of the gate driving signal Gout, and the enable level start time of the gate driving signal Gout output by each stage of shift register G may be shifted in sequence. Accordingly, data on each pixel 20 in the display panel 100 may be refreshed.

It may be understood that when the display mode of the display panel 100 is the second mode, during the display time DT1 (DT2) of each frame of the display panel 100, each stage of the shift register G may output the gate driving signal Gout whose enable level start time is shifted in sequence. As such, each pixel 20 in the display panel 100 may refresh data at a fixed rate. Accordingly, the low display luminescence brightness of the pixel 20 due to the pixel 20 not refreshed for a long time may be avoided. Thus, when the display mode of the display panel 100 is the second mode, by keeping the selection control signal Vctrl at the enable level, the display uniformity of the display panel 100 may be improved, and the display panel 100 may have a high display brightness.

It should be noted that the above description is only an exemplary description of a specific structure of the shift register and a specific operation principle of the shift register. The present disclosure does not limit a specific structure and a specific operation principle of the shift register.

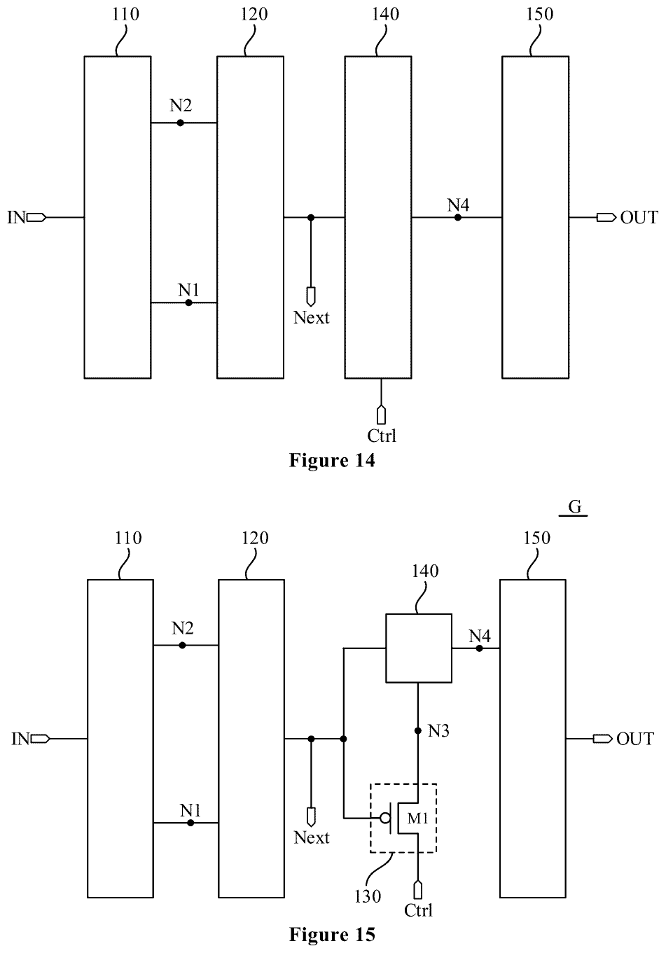

FIG. 14 illustrates a schematic structural diagram of another shift register consistent with the disclosed embodiments of the present disclosure. In some other embodiments, referring to FIG. 14, the shift register G may only include a shift control module 110, a shift output module 120, an output control module 140 and a signal output module 150. In a same shift register G, the shift control module 110 is configured to at least receive an input signal Vin and control a signal at the first node N1 and a signal at the second node N2. The shift output module 120 is configured to at least receive the signal of the first node N1 and the signal of the second node N2, and control the shift signal Vnext. The output control module 140 is configured to at least receive a selection control signal Vctrl and a shift signal Vnext, and control a signal of a fourth node N4. The signal output module 150 is configured to at least receive the signal of the fourth node N4 and control the output of the gate driving signal Gout.

During the display time of a frame, in the shift register G at each stage, the shift register G whose output gate driving signal Gout includes the enable level is the third shift register. In the third shift register, the enable level time of the gate driving signal Gout is equal to the enable level time of the shift signal Vnext.

It may be understood that the third shift register G is a shift register whose output gate driving signal Gout includes the enable level. That is, within the display time of a frame, except for the shift register G whose output gate driving signal Gout is at a non-enable level, each of other shift registers G is the third shift register. During the display time of some frames of the display panel, part of the shift registers of the driving circuit may be the third shift registers. During the display time of some frames of the display panel, each of shift registers in the driving circuit may be the third shift register. During some frame display times of the display panel, the driving circuit may not include the third shift register. The display panel may be specifically designed according to actual needs, and the present disclosure does not limit whether the driving circuit includes the third shift register.

In one embodiment, with reference to FIGS. 3, 12 and 14, for each shift register G, the gate driving signal Gout output by the (i+1)-th stage shift register Gi+1 to the j-th stage shift register Gj may include an enable level, while the gate driving signal output by the other shift registers G may be at a non-enable level. That is, the (i+1)-th stage shift register Gi+1 to the j-th stage shift register Gj each may be the third shift registers. In this case, the output control module 140 in each stage of the third shift register G may directly control the signal of the fourth node N4 according to the shift signal Vnext and the selection control signal Vctrl received. As such, the signal of the fourth node N4 may control the signal output module 150 when the shift signal Vnext is at the enable level. Accordingly, the enable level time of the gate driving signal Gout output by a same third shift register G may be consistent with the enable level time of the shift signal Vnext. As a result, when the gate driving signal Gout is configured to control the pixel 20 to refresh data, each pixel 20 electrically connected to the third shift register G may have a sufficiently long time for refreshing data. Accordingly, the accuracy of data refreshing of each pixel 20 may be improved, and the display effect of the display panel may be improved.

It should be noted that the above description is merely an exemplary description of the structure of each stage of the shift register and the operation principle of outputting gate driving signals. Provided that each stage of shift register may accurately output gate driving signals, the present disclosure does not limit a specific structure and an operation principle of each stage of shift register. The shift register structure of the present disclosure is exemplarily described below with typical examples.

FIG. 15 illustrates a schematic structural diagram of another shift register consistent with the disclosed embodiments of the present disclosure. In one embodiment, as shown in FIG. 15, the selection control module 130 may include a first selection transistor M1. A first terminal of the first selection transistor M1 receives the selection control signal Vctrl, and a second terminal of the first selection transistor M1 is electrically connected to the third node N3. A gate of the first selection transistor M1 receives the shift signal Vnext.

When the selection control signal terminal Ctrl provides the selection control signal Vctrl, and the shift output module 120 outputs the shift signal Vnext to the shift signal output terminal Next, the first terminal of the first selection transistor M1 may be electrically connected to the selection signal terminal Vctrl, and the gate of the first selection transistor M1 may be electrically connected to the shift signal output terminal Next. As such, the first selection transistor M1 may be turned on or off under the control of the shift signal Vnext of the shift signal output terminal Next. When the shift signal Vnext controls the first selection transistor M1 to be turned on, the selection control signal Vctrl may be transmitted to the third node N3 through the first selection transistor M1, such that the signal of the third node N3 may be consistent with the selection control signal Vctrl. That is, during the time when the shift signal Vnext controls the first selection transistor M1 to be turned on, when the selection control signal Vctrl is at the enable level, the signal at the third node N3 may be also at the enable level. When the selection control signal Vctrl is at a non-enable level, the signal at the third node N3 may be also at a non-enable level. When the shift signal Vnext controls the first selection transistor M1 to be turned off, the selection control signal Vctrl may not be transmitted to the third node N3. As such, the third node N3 may not be affected by the change of the selection control signal Vctrl, and the stability of the signal at the third node N3 may be improved. Accordingly, when the output control module 140 provides the signal of the fourth node N4 to the signal output module 150 according to the signal of the third node N3 and the shift signal Vnext, the stability of the signal of the fourth node N4 may be improved. As a result, the signal output module 150 may accurately output the gate driving signal Gout according to the signal of the fourth node N4.

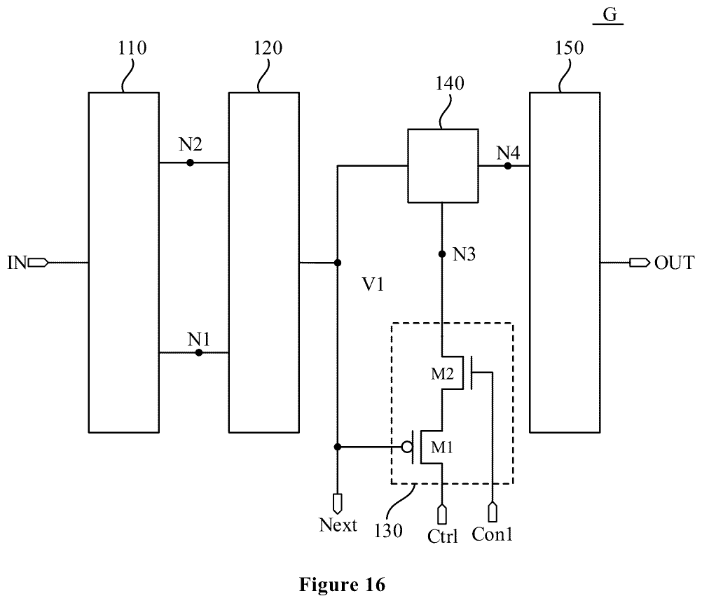

FIG. 16 illustrates a schematic structural diagram of another shift register consistent with the disclosed embodiments of the present disclosure. As shown in FIG. 16, the selection control module 130 may also include a second selection transistor M2 electrically connected between the first selection transistor M1 and the third node N3. A first terminal of the second selection transistor M2 is electrically connected to the second terminal of the first selection transistor M1. A second terminal of the second selection transistor M1 is electrically connected to the third node N3. A gate of the second selection transistor M2 receives a first control signal V1. In a same shift register G, a conduction time of the first selection transistor M1 may overlap a conduction time of the second selection transistor M2.

The second selection transistor M2 electrically connected to the first selection transistor M1 and the third node N3 may be turned on or off under the control of the first control signal V1. The first selection transistor M1 may be turned on or off under the control of the shift signal Vnext. As such, the conduction time of the first selection transistor M1 may be same or different, and the present disclosure does not specially limit whether the conduction time of the first selection transistor M1 is same or different.

Simultaneously, in a same shift register G, the conduction time of the first selection transistor M1 and the second selection transistor M2 may overlap. As such, there is a selection input time, and during the selection input time, the shift signal Vnext controls the first selection transistor M1, and the first control signal V1 controls the second selection transistor M2 to be turned on. Accordingly, the selection control signal Vctrl may be sequentially transmitted to the third node N3 through the first selection transistor M1 and the second selection transistor M2 to control the signal of the third node N3. When at least one of the first selection transistor M1 and the second selection transistor M2 is in an off state, the selection control signal Vctrl may not be transmitted to the third node N3. In this case, the stability of the third node N3 may be prevented from being affected by the change of the selection control signal Vctrl. Accordingly, the accuracy of the signal of the third node N3 may be improved, and the shift register G may accurately output the gate driving signal Gout.

Optionally, still referring to FIG. 16, in a same shift register G, when the overlapping time of the conduction time of the first selection transistor M1 and the conduction time of the second selection transistor M2 is the selection input time, the selection input time of each stage of the shift register G may be shifted in sequence.

The sequential shifting of the gate input time of each stage of shift register G may be understood as: in two adjacent shift registers G, the gating input signal of a previous shift register G is located before the gating input time of a next shift register G. After the first selection transistor M1 and the second selection transistor M2 in the previous stage shift register G finish transmitting the selection control signal Vctrl, the first selection transistor M1 and the second selection transistor M2 in the next stage shift register G may start transmitting the selection control signal Vctrl to the third node N3 thereof. As such, the time for the previous stage shift register and the next stage shift register to transmit the selection control signal may not overlap, and each of the two stages of shift registers G may independently transmit the selection control signal. In this way, when the selection control module 130 includes the first selection transistor M1 and the second selection transistor M2, the gating input time of each stage of the shift register G may be shifted in sequence. As such, the gating input time of each stage of shift register G may not affect each other, and the time when each stage of shift register G transmits the selection control signal Vctrl to the third node N3 may be independent of each other and may not interfere with each other. Accordingly, the accuracy of the signal of the third node N3 in each stage of the shift register G may be improved.

It is understandable that, when the selection control module 130 includes the first selection transistor M1 and the second selection transistor M2 simultaneously, the channel types of the first pass transistor M1 and the second pass transistor M2 may be same or different. That is, the first selection transistor M1 and the second selection transistor M2 may each be N-channel transistors (for example, NMOS transistors). Alternatively, the first selection transistor M1 and the second selection transistor M2 may each be P-channel transistors (for example, PMOS transistors). Alternatively, one of the first selection transistor M1 and the second selection transistor M2 is an N-channel transistor (for example, an NMOS transistor), and the other is a P-channel transistor (for example, a PMOS transistor). The design may be based on actual needs, and the present disclosure does not specifically limit the channel types of the first selection transistor M1 and the second selection transistor M2.

In a preferred embodiment, the first selection transistor M1 and the second selection transistor M2 may have different channel types. In this case, when the first selection transistor M1 is an N-channel transistor (for example, an NMOS transistor), the second selection transistor M2 is a P-channel transistor (for example, a PMOS transistor); or when the first selection transistor M1 is a P-channel transistor (for example, a PMOS transistor), the second selection transistor M2 is an N-channel transistor (for example, an NMOS transistor). In this way, the advantages of the N-channel transistor and the P-channel transistor may be utilized, such that when the first selection transistor M1 and the second selection transistor M2 each are turned on, the selection control signal Vctrl may be used to quickly charge or discharge the third node N3. When the first selection transistor M1 and the second selection transistor M2 are turned off, the leakage current between the selection control signal terminal Ctrl and the third node N3 may be small. Accordingly, the signal at the third node N3 may have high stability.

In one embodiment, in a same shift register G, the input signal Vin may be multiplexed into the first control signal Vcon1. In this way, the number of signals provided to each stage of the shift register G may be reduced. Accordingly, the driving method of the shift register may be simplified, and the driving cost may be reduced.

In one embodiment, the first selection transistor M1 is a PMOS transistor, the second selection transistor M2 is an NMOS transistor, and the enable level of the shift signal Vnext has a high level. The shift signal of the x-th stage shift register is the input signal of the y-th stage shift register, and the enable level start time of the shift signal output by each stage of shift register is shifted in sequence. As an example, when y=x+1, the input signal received by the i-th stage shift register is the shift signal of the (i−1)-th stage shift register, and the input signal received by the (i+1)-th stage shift register is the shift signal of the i-th stage shift register. In this case, the first selection transistor M1 of the i-th stage shift register is turned on during the non-enable level time when the i-th stage shift register outputs the shift signal. The second selection transistor M2 of the i-th stage shift register is turned on at the enable level time when the (i−1)-th stage shift register outputs the shift signal. As such, the time when the first selection transistor M1 and the second selection transistor M2 in the i-th stage shift register are turned on simultaneously. That is, the gating input time of the i-th stage shift register, may be between the enable level start time of the shift signal of the (i−1)-th stage shift register and the enable level start time of the shift signal of the i-th stage shift register. Similarly, the gating input time of the (i+1)-th stage shift register may be between the enable level start time of the shift signal of the i-th stage shift register and the enable level start time of the shift signal of the (i+1)-th stage shift register. As a result, the input time of the i-th stage shift register and the (i+1)-th stage shift register may not overlap, and the selection control signals Vctrl transmitted by the i-th stage shift register and the (i+1)-th stage shift register to the third node N3 may not interfere with each other. Accordingly, the accuracy of the signal of the third node N3 may be improved.

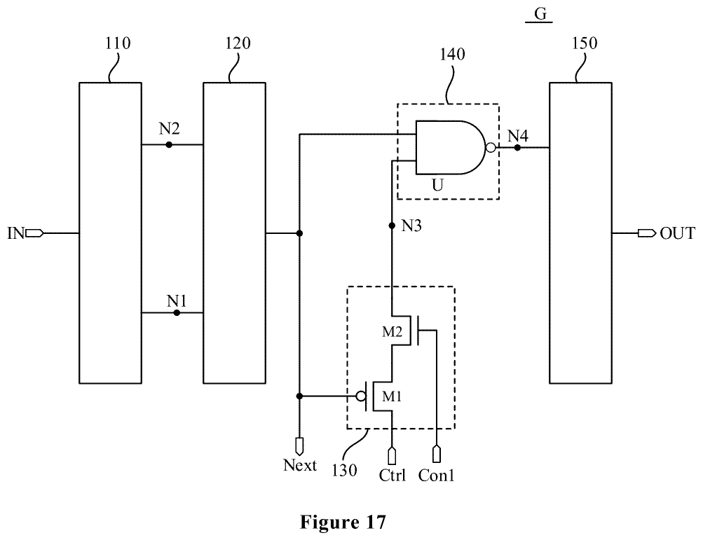

FIG. 17 illustrates a schematic structural diagram of another shift register consistent with the disclosed embodiments of the present disclosure. As shown in FIG. 17, the output control module 140 may include a NAND gate U. A first input terminal of the NAND gate U receives the shift signal Vnext, a second input terminal of the NAND gate U is electrically connected to the third node N3, and an output terminal of the NAND gate U is electrically connected to the fourth node N4.

For the NAND gate U, when the signals received by the first input terminal and the second input terminal each are high level signal, the output terminal may output a low level signal, otherwise the output terminal outputs a high level signal. That is, when the shift signal Vnext and the signal of the third node N3 each are at a high level, the signal of the fourth node N4 is at a low level. When the shift signal Vnext and the signal of the third node N3 have a low level, the signal of the fourth node N4 has a high level. In this way, when the output control module 140 includes the NAND gate U, by properly controlling the signal of the third node N3 and the shift signal Vnext, the signal of the fourth node N4 may be accurately controlled. Accordingly, the signal output module 150 may accurately output the gate driving signal Gout according to the signal of the fourth node N4.

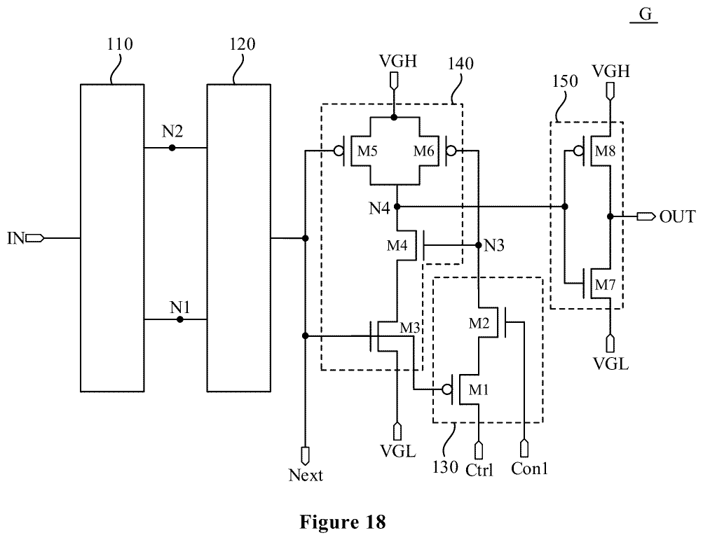

FIG. 18 illustrates a schematic structural diagram of another shift register consistent with the disclosed embodiments of the present disclosure. Optionally, as shown in FIG. 18, the NAND gate may include a first transistor M3, a second transistor M4, a third transistor M5 and a fourth transistor M6. The gate of the first transistor M3 receives the shift signal Vnext, and the gate of the second transistor M4 is electrically connected to the third node N3. The first terminal of the first transistor M3 receives a first level signal Vgl, a second terminal of the first transistor M3 is electrically connected to a first terminal of the second transistor M2, and the second terminal of the second transistor M4 is electrically connected to a fourth node N4. The gate of the third transistor M5 receives the shift signal Vnext, and the gate of the fourth transistor M6 is electrically connected to the third node N3. The first terminal of the third transistor N3 receives the second level signal Vgh, and the second terminal of the third transistor M5 and the second terminal of the fourth transistor M6 are each electrically connected to the fourth node N4. The channel type of the first transistor M3 is different from the channel type of the third transistor M5, and the channel type of the second transistor M4 is different from the channel type of the fourth transistor M6.

It may be understood that the first level signal Vgl and the second level signal Vgh may be two signals with different polarities. Alternatively, the first level signal Vgl and the second level signal Vgh may be two types of signals that respectively control a same transistor to be turned on and off. For example, when the first level signal Vgl is a low level signal and the second level signal Vgh is a high level signal, for a PMOS transistor, the first level signal Vgl may control the transistor to be turned on, and the second level signal Vgh may control the transistor to be turned off. For an NMOS transistor, a first level signal Vgl may control the transistor to be turned off, and a second level signal Vgh may control the transistor to be turned on. On the contrary, when the first level signal Vgl is a high level signal, the second level signal Vgh is a low level signal. For ease of description, without special limitation, the present disclosure will take the example that the first level signal is a low level signal and the second level signal is a high level signal to exemplarily illustrate the technical solutions of the present disclosure.

The first level signal Vgl may be provided by the first level terminal VGL, such that the first terminal of the first transistor M3 is electrically connected to the first level terminal VGL. The second level signal Vgl may be provided by the second level terminal VGH, such that the first terminals of the third transistor M5 and the fourth transistor M6 may be electrically connected to the second level terminal VGH.

In addition, the channel type of the first transistor M3 may be different from the channel type of the third transistor M5, and the channel type of the second transistor M4 may be different from the channel type of the fourth transistor M6. That is, the first transistor M3 may be set as an NMOS transistor, and the third transistor M5 may be set as a PMOS transistor. Alternatively, the first transistor M3 may be a PMOS transistor, and the third transistor M5 may be an NMOS transistor. When the shift signal Vnext controls the first transistor M3 to be turned on, the third transistor M5 may be turned off, and when the shift signal Vnext controls the third transistor M5 to be turned on, the first transistor M3 is turned off. That is, the first transistor M3 and the third transistor M5 may be turned on in a time-sharing manner.

Similarly, the second transistor M4 may be set as an NMOS transistor, and the fourth transistor M6 may be set as a PMOS transistor; or the second transistor M4 may be a PMOS transistor, and the fourth transistor M6 may be set as an NMOS transistor. When the signal at the third node N3 controls the second transistor M4 to be turned on, the fourth transistor M6 may be turned off. When the signal at the third node N3 controls the fourth transistor M6 to be turned on, the second transistor M4 may be turned off. That is, the fourth transistor M6 and the second transistor M4 may also be turned on in a time-sharing manner. In this way, by controlling the first transistor M3 and the third transistor M5 to be turned on in a time-sharing manner, and controlling the second transistor M4 and the fourth transistor M6 to be turned on in a time-sharing manner, accurate control of the signal of the fourth node N4 may be realized, and the first level terminal VGL and the second level terminal VGH may be prevented from forming a current path, and thus the transistors in the path may not be impacted and damaged by a large current.

In one embodiment, the channel types of the first transistor M3 and the second transistor M4 each are N-type. During the display time of a frame, the shift signal Vnext may be in a low level state for a long time. If the channel type of the first transistor M3 is set to P type, the first transistor M3 may be turned on for a long time. As a result, the threshold voltage of the transistor may drift, the electrical properties of the first transistor M3 may thus be affected, and the switching control of the first transistor M3 may thus be inaccurate. When the channel type of the first transistor M3 is set to N-type, the first transistor M3 may be turned off for a long time under the control of the shift signal Vnext. As such, the possibility of threshold drift may be reduced, and the electrical stability of the first transistor M3 may be improved. Similarly, by setting the channel type of the second transistor M4 to N-type, the possibility of threshold drift of the second transistor M4 may be reduced, and the electrical stability of the second transistor M4 may be improved.

FIG. 18 illustrates a schematic structural diagram of another shift register consistent with the disclosed embodiments of the present disclosure. For ease of understanding, the operation principles of the selection control module and the output control module in the shift register are explained by taking the shift register shown in FIG. 18 as an example. It should be noted that, in FIG. 18, the first selection transistor M1, the third transistor M5 and the fourth transistor M6 each are PMOS transistors that may be turned on at a low level, and the second selection transistor M2, the first transistor M3 and the second transistor M4 are NMOS transistors that may be turned on at a high level.

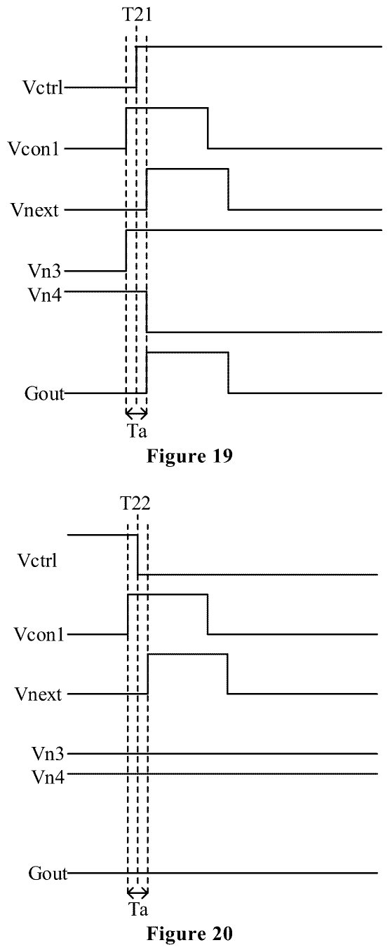

FIG. 19 illustrates a driving timing diagram of a shift register consistent with the disclosed embodiments of the present disclosure. FIG. 20 illustrates a driving timing diagram of another shift register consistent with the disclosed embodiments of the present disclosure. Referring to FIGS. 18-20, in a same shift register G, when the shift signal Vnext is at a low level, the first selection transistor M1 and the third transistor M5 may be controlled to be turned on. The selection control signal Vctrl may be transmitted to the first terminal of the second selection transistor M2 through the first selection transistor M1. If the first control signal Vcon1 for controlling the second pass transistor M2 is at a low level at this time, the second pass transistor M2 may not be in an on state. As such, the selection control signal Vctrl may not be transmitted to the third node N3, and the signal Vn3 of the third node N3 may remain unchanged. When the first control signal Vcon1 for controlling the second selection transistor M2 is at a high level, that is, during the gate input time Ta, the second selection transistor M2 may be in a conduction state. The selection control signal Vctrl may be transmitted to the third node N3, and the signal Vn3 of the third node N3 may be consistent with the selection control signal Vctrl. That is, when the selection control signal Vctrl changes, the signal Vn3 of the third node N3 may change accordingly. When any one of the first selection transistor M1 and the second selection transistor M2 is turned off, the signal Vn3 of the third node N3 may be consistent with the level of the last change of the selection control signal Vctrl during the conduction time of the first selection transistor M1 and the second selection transistor M2. Simultaneously, since the third transistor M5 is in a conduction state, the second level signal Vgh may be transmitted to the fourth node N4. As such, the signal of the fourth node N4 may be consistent with the second level signal Vgh.

When the shift signal Vnext is at a high level, the first transistor M3 may be controlled to be turned on. In this case, if the signal Vn3 of the third node N3 is at a high level before the shift signal Vnext becomes a high level, when the shift signal Vnext is at a high level, the first selection transistor M1 is in a closed state, such that the signal may not be transmitted to the third node N3. As a result, the signal Vn3 of the third node N3 may be kept at a high level, such that the signal Vn3 of the third node N3 may control the second transistor M4 to be turned on, and control the fourth transistor M6 to be turned off. As such, the first level signal Vgl may be transmitted to the fourth node N4, and the signal Vn4 of the fourth node N4 may thus be consistent with the first level signal Vgl. On the contrary, if the signal Vn3 of the third node N3 is at a low level before the shift signal Vnext becomes a high level, when the shift signal Vnext becomes a high level, the signal Vn3 of the third node N3 may control the fourth transistor M6 to be turned on, and control the second transistor M4 to be turned off. As such, the second level signal Vgh may be transmitted to the fourth node N4, and the signal Vn4 of the fourth node N4 may thus be consistent with the second level signal Vgh. In this way, by controlling the signal Vn3 of the third node N3 before the shift signal Vnext becomes a high level, the signal Vn4 of the fourth node N4 may be correspondingly controlled.

It should be noted that the above description is only an exemplary description of the types of transistors and the operation principles of the selection control module and the output control module in the shift register. The present disclosure is not limited thereto and may be designed according to actual needs.

It may be understood that, under the joint action of the selection control module and the output control module, the signal of the fourth node may change between a low level and a high level. As such, the signal of the fourth node may make the signal output module to accurately output the gate driving signal. The manner in which the signal output module outputs the gate driving signal may be designed according to actual needs, and is not specifically limited by the present disclosure.

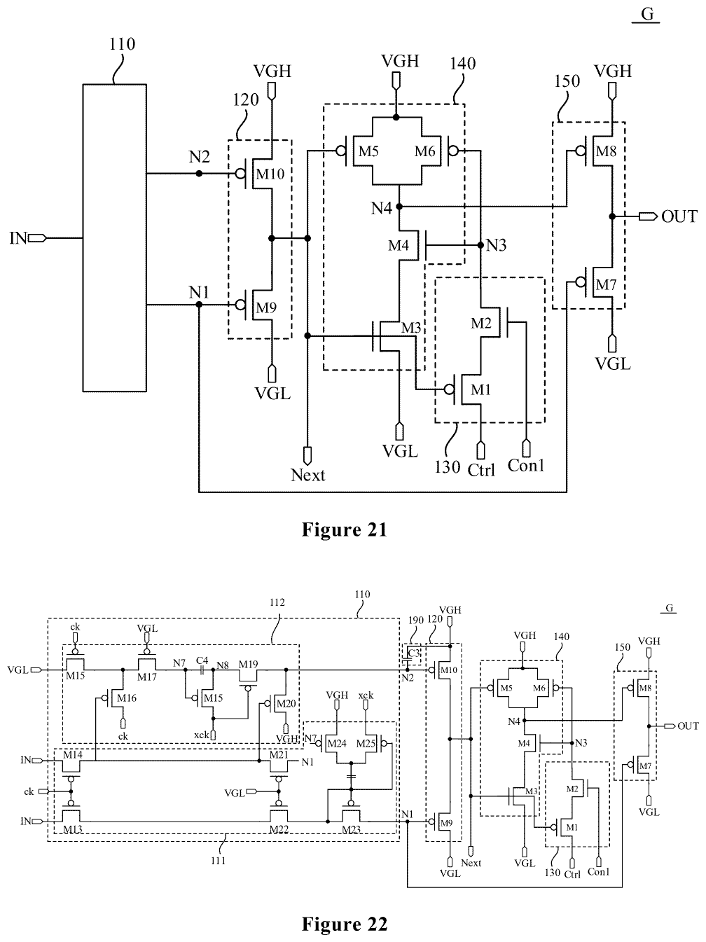

FIG. 21 illustrates a schematic structural diagram of another shift register consistent with the disclosed embodiments of the present disclosure. In one embodiment, as shown in FIGS. 18-21, the signal output module 150 may include a third output transistor M7 and a fourth output transistor M8. The gate of the third output transistor M7 is electrically connected to the fourth node N4 (as shown in FIG. 18) or the first node N1 (as shown in FIG. 21). The first terminal of the third output transistor M7 receives the first level signal, and the second terminal of the third output transistor M7 is configured to output the gate driving signal Gout. The gate of the fourth output transistor M8 is electrically connected to the fourth node, and the first terminal of the fourth output transistor M8 receives the second level signal. The second terminal of the fourth output transistor M8 is configured to output the gate driving signal Gout.

One of the third level signal and the fourth level signal may be an enable level of the gate driving signal Gout, and the other may be a non-enable level of the gate driving signal Gout. That is, the third level signal and the fourth level signal may have different polarities. For example, the third level signal may multiplex the first level signal Vgl, and the fourth level signal may multiplex the second level signal Vgh. In this case, the third level signal may be provided by the first level terminal VGL, and the fourth level signal may be provided by the second level terminal VGH. As such, the first terminal of the third output transistor M7 may be electrically connected to the first level terminal VGL, and the first terminal of the fourth output transistor M8 may be electrically connected to the second level terminal VGH.

In an example, the third level signal is a low level signal, the fourth level signal is a high level signal, the enable level of the gate driving signal Gout is a high level signal, and the non-enable level of the gate driving signal Gout as a low level signal. To output the enable level of the gate driving signal Gout, the fourth output transistor M8 may be controlled to be turned on. To output a non-enable level of the gate driving signal Gout, the third output transistor M7 may be controlled to be turned on. In this case, to accurately output the gate driving signal Gout, the third output transistor M7 and the fourth output transistor M8 may need to be turned on in different time periods.

In one embodiment, as shown in FIG. 18, since the gates of the third output transistor M7 and the fourth output transistor M8 each are electrically connected to the fourth node N4, the signal of the fourth node N4 needs to control the third output transistor M7 and the fourth output transistor M8 to be turned on in different time periods. In this case, the third output transistor M7 and the fourth output transistor M8 may be transistors of different channel types. For example, the third output transistor M7 may be an N-channel transistor, and the fourth output transistor M8 may be a P-channel transistor. When the signal at the fourth node N4 is at a high level, the third output transistor M7 may be controlled to be turned on and the fourth output transistor M8 may be turned off. Accordingly, the third level signal Vgl may be transmitted to the driving signal output terminal OUT through the third output transistor M7, such that the gate driving signal Gout output by the driving signal output terminal OUT may be consistent with the third level signal Vgl. When the signal at the fourth node N4 is at a low level, the fourth output transistor M8 may be controlled to be turned on, and the third output transistor M7 may be turned off. Accordingly, the third level signal Vgh may be transmitted to the driving signal output terminal OUT through the fourth output transistor M8, such that the gate driving signal Gout output by the driving signal output terminal OUT may be consistent with the fourth level signal Vgh.

In another embodiment, as shown in FIG. 21, the third output transistor M7 may be turned on or off under the control of the signal of the first node N1, and the fourth output transistor M8 may be turned on or off under the control of the signal of the fourth node N4. In this way, when the first node N1 controls the third output transistor M7 to be turned on, the gate driving signal Gout output by the driving signal output terminal OUT may be consistent with the third level signal Vgl. When the fourth node N4 controls the fourth output transistor M8 to be turned on, the gate driving signal Gout output by the driving signal output terminal OUT may be consistent with the fourth level signal Vgh. In this case, the channel types of the third output transistor M7 and the fourth output transistor M8 may be same or different, and may be designed according to actual needs. In one embodiment, the third output transistor M7 and the fourth output transistor M8 may each be P-channel transistors. When the third output transistor M7 is turned on, the third level signal Vgl may be quickly transmitted to the driving signal output terminal OUT. When the fourth output transistor M8 is turned on, the fourth level signal Vgh may be quickly transmitted to the driving signal output terminal OUT. Accordingly, the gate driving signal Gout of the driving signal output terminal OUT may flip quickly, and the accuracy of the gate driving signal Gout may be improved.

It may be understood that when the gate driving signal Gout output by the shift register G includes an enable level, the gate driving signal Gout may be consistent with the shift signal Vnext. In this case, the shift output module 120 for controlling the shift signal Vnext may have a same structure as or different from the signal output module 150. Provided that the shift signal Vnext and the gate driving signal Gout may be accurately output, the present disclosure does not specifically limit the structures of the shift output module 120 and the signal output module 150.

Optionally, still referring to FIG. 21, the shift output module 120 may include a first output transistor M9 and a second output transistor M10. The gate of the first output transistor M9 is electrically connected to the first node N1, the first terminal of the first output transistor M9 receives the first level signal Vgl, and the second terminal of the first output transistor M9 is configured to output the shift signal Vnext. The gate of the second output transistor M10 is electrically connected to the second node N2, the first terminal of the second output transistor M10 receives the second level signal Vgh, and the second terminal of the second output transistor M10 is configured to output the shift signal Vnext.

The first output transistor M9 may be turned on or off under the control of the signal of the first node N1. The second output transistor M10 may be turned on or off under the control of the second node N2. When the signal at the first node N1 controls the first output transistor M9 to be turned on, the first level signal Vgl may be transmitted to the shift signal output terminal Next through the first output transistor M9, such that the shift signal Vnext may be consistent with the first level signal Vgl. When the signal at the second node N2 controls the second output transistor M10 to be turned on, the second level signal Vgh may be transmitted to the shift signal output terminal Next through the second output transistor M10, such that the shift signal Vnext may be consistent with the second level signal Vgh. In this way, when the first level signal Vgl and the second level signal Vgh are respectively the non-enable level and the enable level of the shift signal Vnext, by controlling the conduction time of the first output transistor M9 and the second output transistor M10 respectively, the shift signal output terminal Next may accurately output the non-enable level or the enable level of the shift signal Vnext.

In an example, the enable level of the shift signal Vnext and the gate driving signal Gout are at a high level, the non-enable level is at a low level. The first level signal Vgl and the third level signal are low level signals, and the second level signal Vgh and the fourth level signal are high level signals. When the gates of the first output transistor M9 and the third output transistor M7 each are electrically connected to the first node N1, the first output transistor M9 and the second output transistor M7 may have a same channel type. As such, the signal of the first node N1 may control the first output transistor M9 and the second output transistor M7 to be turned on or off simultaneously. Accordingly, when the shift signal Vnext is at a non-enable level, the gate driving signal Gout may be driven to be at a non-enable level, and the signals of stage level of the shift register may thus be accurately transmitted.

It may be understood that, since the first output transistor M9 and the second output transistor M10 may be turned on or off under the control of the signals at the first node N1 and the second node N2, respectively, the channel types of the first output transistor M9 and the second output transistor M10 may be same or different. The present disclosure does not specifically limit whether the channel types of the first output transistor M9 and the second output transistor M10 are same or different. In one embodiment, the first output transistor M9 and the second output transistor M10 each are P-channel transistors. As such, when the first output transistor M9 is turned on, the first level signal Vgl may be quickly transmitted to the shift signal output terminal Next. When the second output transistor M10 is turned on, the second level signal Vgh may be quickly transmitted to the shift signal output terminal Next. Accordingly, the shift signal Vnext of the shift signal output terminal Next may be quickly flipped, and the accuracy of the shift signal Vnext may be improved.

In one embodiment, when the selection control module 130 includes a first selection transistor M1 and a second selection transistor M2, the second selection transistor M2 may have a different channel type from the first output transistor M9. For example, when the second selection transistor M2 is an N-channel transistor, the first output transistor M9 may be a P-channel transistor. When the second selection transistor M2 is a P-channel transistor, the first output transistor M9 may be an N-channel transistor.

Specifically, during one frame, since the shift signal Vnext may remain at a non-enabled level for a long time, the first selection transistor M1 may be in a conduction state for a long time, and the conduction time of the first selection transistor M1 of each stage of the shift register G may overlap. To make the signals transmitted from the selection control signal Vctrl to the third node N3 of each stage of the shift register G do not affect each other, the conduction time of the first selection transistor M1 and the second selection transistor M2 of each stage of the shift register G may be controlled not to overlap. That is, the time during which the first selection transistor M1 and the second selection transistor M2 of each stage of the shift register G are simultaneously turned on may be relatively short.

When the first control signal Vcon1 for controlling the second pass transistor M2 multiplexes the input signal Vin, to avoid that the second pass transistor M2 and the first pass transistor M1 may be simultaneously turned on for a short period of time, the second pass transistor M2 may be controlled to be turned on when the input signal Vin is at the enable level. In this case, when the input signal Vin of a current stage shift register is the shift signal Vnext of a previous stage shift register, the time when the first selection transistor M1 and the second selection transistor M2 in the current stage shift register are turned on simultaneously may be the overlapping time of the enable level time of the shift signal Vnext of the previous stage shift register and the non-enable level time of the shift signal Vnext of the current stage shift register.

In addition, the signal of the first node N1 may be controlled by the input signal Vin and the shift control module 110. For example, the shift control module 110 may control the time when the input signal Vin is written into the first node N1, such that when the shift control module 110 controls the input signal Vin to be written into the first node N1, the signal of the first node N1 may be consistent with the input signal Vin. In this case, the signal used to control the first output transistor M9 to be turned on or off is the input signal Vin. Further, when the first output transistor M9 is turned on, the non-enable level of the shift signal may be output, and when the first output transistor M9 is turned off, the enable level of the shift signal may be output. As such, to make the first output transistor M9 accurately output the non-enable level of the shift signal Vnext, and the time when the first selection transistor M1 and the second selection transistor M2 are simultaneously turned on be a short time, the first output transistor M9 and the second selection transistor M2 may be set to be transistors having different channel types. As such, under the premise of reducing the number of signals provided to the shift register G and simplifying the driving method of the shift register G, the time for the shift registers G at each level to transmit the selection control signal Vctrl to the third node N3 may not overlap.

It should be noted that the above description is merely an example of the shift control module 110 controlling the signal of the first node N1 to be consistent with the input signal Vin for at least part of the time. The present disclosure does not limit a specific control method of the shift control module on the signals of the first node N1 and the second node N2.

FIG. 22 illustrates a schematic structural diagram of another shift register consistent with the disclosed embodiments of the present disclosure. Optionally, as shown in FIG. 22, the shift control module 110 may include a first shift control unit 111 and a second shift control unit 112. The first shift control unit 111 is configured to receive at least an input signal Vin, a first clock signal CK and a second clock signal XCK, and control the signal of the first node N1. The second shift control unit 112 is configured to at least receive the first clock signal CK, the second clock signal XCK, the first level signal Vgl and the signal of the first node N1, and control the signal of the second node N2.

The first clock signal CK and the second clock signal XCK may periodically change. The first clock signal CK and the second clock signal XCK may each include a valid pulse and an invalid pulse. The valid pulse time of the first clock signal CK and the valid pulse time of the second clock signal XCK may not overlap. That is, the valid pulse time of the first clock signal CK may overlap with the invalid pulse time of the second clock signal XCK, and the valid pulse time of the second clock signal XCK may overlap with the invalid pulse time of the first clock signal CK.

Specifically, the first shift control unit 111 may control the signal of the first node N1 according to the input signal Vin, the first clock signal CK and the second clock signal XCK received by the first shift control unit 111. As such, the signal of the first node N1 may control the first output transistor M9 to be turned on or off. The second shift control unit 112 may control the signal of the second node N2 according to the first clock signal CK, the second clock signal XCK, the first level signal Vgl and the signal of the first node N1 received by the second shift control unit 112. As such, the signal at the second node N2 may control the second output transistor M10 to be turned on or off. Since the first output transistor M9 and the second output transistor M10 may be turned on in in a time-sharing manner, when the channel types of the first output transistor M9 and the second output transistor M10 are same, the first shift control unit 111 may control the polarity of the signal of the first node N1 to be opposite to the polarity of the signal of the second node N2. Accordingly, the second shift control unit 112 may control the polarity of the signal at the second node N2 to be opposite to the polarity of the signal at the first node N1.

In one embodiment, the first shift control unit 111 may include a thirteenth transistor M13, a fourteenth transistor M14, a twenty-third transistor M23, a twenty-fourth transistor M24, a twenty-fifth transistor M25, and a fifth capacitor C5.

The thirteenth transistor M13 and the fourteenth transistor M14 may be transistors with a same function. That is, the first terminal of the thirteenth transistor M13 receives the input signal Vin, the second terminal is connected to the fifth node N5, and the gate is electrically connected to the first clock terminal ck to receive the first clock signal CK. The first terminal of the fourteenth transistor M14 receives the input signal Vin, the second terminal is connected to the first node N1, and the gate is electrically connected to the first clock terminal ck to receive the first clock signal CK. That is, the signal of the fifth node N5 may be controlled by the thirteenth transistor M13, and the signal of the first node N1 may be controlled by the fourteenth transistor M14.

The first terminal and the gate of the twenty-third transistor M23 each are connected to the fifth node N5, and the second terminal is connected to the first node N1. The first plate of the fifth capacitor C5 is connected to a fifth node N5, and the second plate of the fifth capacitor C5 is connected to a sixth node N6. The first terminal of the twenty-fourth transistor M24 receives the second level signal Vgh, the second terminal is connected to the sixth node N6, and the gate is electrically connected to the second shift control unit 112. The first terminal of the twenty-fifth transistor M25 is electrically connected to the second clock terminal xck to receive a second clock signal XCK from the second clock terminal xck, the second terminal is connected to the eighteenth node N18, and the gate is connected to the fifth node N5. In this case, the twenty-fourth transistor M24 may be turned on or off under control of the second shift control unit 12, and may transmit the second level signal Vgh to the sixth node N6 when the twenty-fourth transistor M24 is turned on. The twenty-fifth transistor M25 may be turned on or off under control of the signal at the fifth node N5. When the signal at the fifth node N5 controls the twenty-fifth transistor M25 to be turned on, the second clock signal XCK may be controlled to be transmitted to the sixth node N6. As such, the signal of the sixth node N6 may change between the second level signal Vgh and the second clock signal XCK. Simultaneously, based on the charge conservation principle of a capacitor, when the signal of the second plate of the fifth capacitor C5 changes, the signal of the second plate thereof may change accordingly. In this way, when the signal of the sixth node N6 is controlled to change, the signal of the fifth node N5 and the signal of the sixth node N6 may be controlled to have a same change.

In addition, the gate electrode and the first terminal of the twenty-third transistor M23 are each electrically connected to the fifth node N5. When the first terminal of the twenty-third transistor M23 is the source and the second terminal is the drain, by electrically connecting the gate of the twenty-third transistor M23 to the first terminal, the twenty-third transistor M23 may be turned on only when the signal at the fifth node N5 is lower than the signal at the first node N1, and thus the signal of the fifth node N5 with a relatively low level may be supplemented to the first node N1. As such, the signal of the first node N1 may accurately control the first output transistor M9 to be in a conduction state for a relatively long time. Accordingly, the non-enable level of the shift signal Vnext may output for a long time.

Optionally, the first shift control unit may also include a first voltage stabilizing transistor M21. The first voltage stabilizing transistor M21 may be electrically connected between the second terminal of the fourteenth transistor M14 and the first node N1. That is, the gate of the first voltage stabilizing transistor M21 receives the voltage stabilizing control signal, the first terminal is electrically connected to the second terminal of the fourteenth transistor M14, and the second terminal is electrically connected to the first node N1. The voltage stabilizing control signal may control the first voltage stabilizing transistor M21 to be in a conduction state when the difference between the first terminal signal of the first voltage stabilizing transistor M21 and the signal of the first node N1 is within a preset range. As such, the first terminal signal of the first voltage stabilizing transistor M21 and/or the signal of the first node N1 may not increase or decrease instantaneously, and the stability of the signal at the first terminal of the first voltage stabilizing transistor M21 or the signal at the first node N1 may not be affected. Accordingly, the operation stability of the shift register G may be improved.

Optionally, the first shift control unit may also include a second voltage stabilizing transistor M22, and the second voltage stabilizing transistor M22 may be electrically connected between the second terminal of the thirteenth transistor M13 and the fifth node N5. That is, the gate of the second voltage stabilizing transistor M22 receives the voltage stabilizing control signal, the first terminal is electrically connected to the second terminal of the thirteenth transistor M13, and the second terminal is electrically connected to the fifth node N5. The voltage stabilizing control signal may control the second voltage stabilizing transistor M22 to be in a conduction state when the difference between the first terminal signal of the second voltage stabilizing transistor M22 and the signal of the fifth node N5 is within a preset range. As such, the first terminal signal of the second voltage stabilizing transistor M22 and/or the signal of the fifth node N5 may not increase or decrease instantaneously, and the stability of the signal at the first terminal of the second voltage stabilizing transistor M22 or the signal at the fifth node N5 may not be affected. Accordingly, the operation stability of the shift register G may be improved.

Optionally, still referring to FIG. 22, the second shift control unit 112 may include a fifteenth transistor M15, a sixteenth transistor M16, an eighteenth transistor M18, a nineteenth transistor M19, a twentieth transistor M20, and a fourth capacitor C4.

The first terminal of the fifteenth transistor M15 receives the first level signal Vgl, the second terminal is connected to the seventh node N7, and the gate is electrically connected to the first clock terminal ck to receive the first clock signal CK. The gate of the sixteenth transistor M16 is connected to the first node N1 or the first terminal of the first voltage-stabilizing transistor M21, the second terminal is electrically connected to the first clock terminal ck to receive the first clock signal CK, and the second terminal is connected to the seventh node N7. In this way, the fifteenth transistor M15 and the sixteenth transistor M16 may jointly control the signal of the seventh node N7. That is, when the first clock signal CK controls the fifteenth transistor M15 to be turned on, the signal of the seventh node N7 may be consistent with the first level signal Vgl. When the signal at the first node N1 controls the sixteenth transistor M16 to be turned on, the signal at the seventh node N7 may be consistent with the first clock signal CK.

The gate of the eighteenth transistor M18 is electrically connected to the seventh node N7, the first terminal is electrically connected to the second clock terminal xck to receive the second clock signal XCK, and the second terminal is electrically connected to the eighth node N8. The first plate of the fourth capacitor C4 is connected to a seventh node N7, and the second plate is connected to an eighth node N8. In this case, the signal of the seventh node N7 may control the eighteenth transistor M18 to be turned on or off. When the eighteenth transistor M18 is turned on, the second clock signal XCK may be transmitted to the eighth node N8 to control the signal of the eighth node N8. Meanwhile, a fourth capacitor C4 may be disposed between the eighth node N8 and the seventh node N7, such that the signal of the seventh node N7 and the signal of the eighth node N8 may have a same variation trend.

The first terminal of the nineteenth transistor M19 is connected to the eighth node N8, the second terminal is connected to the second node N2, and the gate is electrically connected to the second clock terminal xck to receive the second clock signal XCK. The first terminal of the twentieth transistor M20 receives the second level signal Vgh, the second terminal is connected to the second node N2, and the gate is connected to the first node N1 or connected to the first node N1 through the first voltage stabilizing transistor M21. In this case, the nineteenth transistor M19 and the twentieth transistor M20 may jointly control the signal of the second node N2. When the second clock signal XCK controls the nineteenth transistor M19 to be turned on, the signal of the second node N2 may be kept consistent with the signal of the eighth node N8. When the signal at the first node N1 controls the twentieth transistor M20 to be turned on, the signal at the second node N2 may be kept consistent with the second level signal Vgh.

Optionally, the second shift control unit 112 may also include a third voltage stabilizing transistor M17. The third voltage stabilizing transistor M17 is electrically connected between the second terminal of the fifteenth transistor M15 and the seventh node N7. That is, the gate of the third voltage-stabilizing transistor M17 receives the voltage-stabilizing control signal, the first terminal is electrically connected to the second terminal of the fifteenth transistor M15, and the second terminal is electrically connected to the seventh node N7. In this case, the sixteenth transistor M16 may be directly electrically connected to the seventh node N7 or electrically connected to the seventh node N7 through the third voltage stabilizing transistor M17. The voltage stabilizing control signal may control the third voltage stabilizing transistor M17 to be in a conduction state when the difference between the first terminal signal of the third voltage stabilizing transistor M17 and the signal of the seventh node N7 is within a preset range. As such, the first terminal signal of the third voltage stabilizing transistor M17 and/or the signal of the seventh node N7 may not increase or decrease instantaneously, and the stability of the signal at the first terminal of the third voltage stabilizing transistor M17 or the signal at the seventh node N7 may not be affected. Accordingly, the operation stability of the shift register G may be improved.

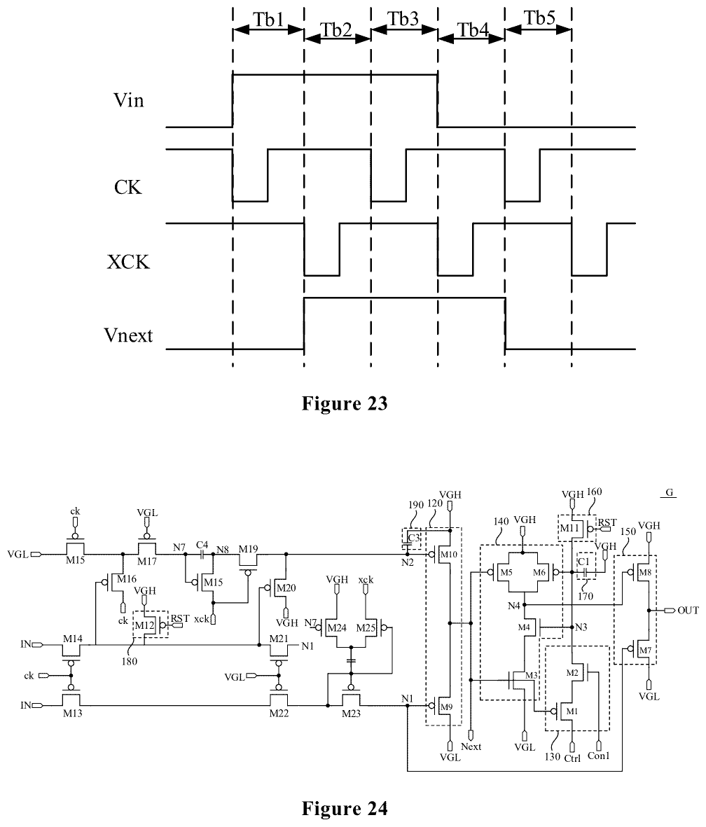

FIG. 23 illustrates a schematic structural diagram of another shift register consistent with the disclosed embodiments of the present disclosure. Referring to FIGS. 22 and 23, the operation principle and operation process of the shift control module in the shift register of the present disclosure are described below.

In the Tb1 phase, the input signal Vin is at a high level, and the first clock signal CK is at a low level. In this case, the thirteenth transistor M13, the fourteenth transistor M14 and the fifteenth transistor M15 are turned on. The input signal Vin is transmitted to the first node N1 and the fifth node N5 through the thirteenth transistor M13 and the fourteenth transistor M14, respectively. As such, the first node N1 and the fifth node N5 each may be at high level, and the sixteenth transistor M16 and the twentieth transistor M20 may be turned off. In addition, the first level signal Vgl is transmitted to the seventh node N7 through the fifteenth transistor M15, the seventh node N7 is at a low level, and the eighteenth transistor M18 is turned on. The second clock signal XCK is at a high level, the eighth node N8 maintains a high level, and the nineteenth transistor M19 is turned off. The second node N2 maintains the signal written in a previous cycle, that is, the fifth node N5 is a high level signal. The second output transistor M10 is turned off, such that the shift signal Vnext remains at a low level.

In the Tb2 phase, the input signal Vin remains at a high level, and the first clock signal CK is at a high level. In this case, the thirteenth transistor M13, the fourteenth transistor M14 and the fifteenth transistor M15 are turned off, the first node N1 and the fifth node N5 maintain at a high level, and the sixteenth transistor M16 and the twentieth transistor M20 are turned off. The seventh node N7 maintains at a low level, and the eighteenth transistor M18 is turned on. The low level of the second clock signal XCK may be transmitted to the eighth node N8 through the eighteenth transistor M18, such that the eighth node N8 may be at a low level. The nineteenth transistor M19 is turned on, and the signal of the eighth node N8 is transmitted to the second node N2, such that the second node N2 may be at a low level. The second output transistor M10 is turned on, and the second level signal Vgh is transmitted to the shift signal output terminal Next, such that the output shift signal Vnext may become to be at a high-level signal.

In the Tb3 phase, the input signal Vin remains at a high level, and the first clock signal CK is at a low level. In this case, the thirteenth transistor M13, the fourteenth transistor M14 and the fifteenth transistor M15 are turned on. The input signal Vin may be transmitted to the first node N1 and the fifth node N5 through the thirteenth transistor M13 and the fourteenth transistor M14, respectively, such that the first node N1 and the fifth node N5 each are at high level, and the sixteenth transistor M16 and the twentieth transistor M20 are turned off. In addition, the first level signal Vgl is transmitted to the seventh node N7 through the fifteenth transistor M15, the seventh node N7 is at a low level, and the eighteenth transistor M18 is turned on. The second clock signal XCK is at a high level, the eighth node N8 maintains at a high level, the nineteenth transistor M19 is turned off, and the fifth node N5 maintains a low level. The second output transistor M10 is turned on, such that the shift signal Vnext may maintain at a high level.

In the Tb4 phase, the input signal Vin is at a low level, and the first clock signal CK is at a high level. The thirteenth transistor M13, the fourteenth transistor M14 and the fifteenth transistor M15 each are turned off. The first node N1 and the fifth node N5 each maintain at a high level, and the sixteenth transistor M16 and the twentieth transistor M20 each are turned off. The seventh node N7 maintains at a low level, and the eighteenth transistor M18 is turned on. The low level of the second clock signal XCK may be transmitted to the eighth node N8 through the eighteenth transistor M18, such that the eighth node N8 may be at a low level. The nineteenth transistor M19 is turned on, and the signal of the eighth node N8 may be transmitted to the second node N2. The signal of the second node N2 is at a low level, and the second output transistor M10 is turned on. The second level signal Vgh may be transmitted to the shift signal output terminal Next, such that the shift signal Vnext may maintain at a high level.

In the Tb5 phase, the input signal Vin is at a low level, and the first clock signal CK is at a low level. The thirteenth transistor M13, the fourteenth transistor M14 and the fifteenth transistor M15 are turned on. The input signal Vin may be transmitted to the first node N1 and the fifth node N5 through the thirteenth transistor M13 and the fourteenth transistor M14, respectively, such that the first node N1 and the fifth node N5 each are at a low level, and the sixteenth transistor M16 and the twentieth transistor M20 are turned on. In addition, the fifteenth transistor M15 is turned on, and the first level signal Vgl may be transmitted to the seventh node N7 through the fifteenth transistor M15. The seventh node N7 is at a low level, and the eighteenth transistor M18 is turned on. The second clock signal XCK is at a high level, the eighth node N8 maintains a high level, and the nineteenth transistor M19 is turned off. The twentieth transistor M20 is turned on. The second level signal Vgh may be transmitted to the second node N2 through the twentieth transistor M20, such that the second node N2 may be at a high level and the second output transistor M10 may be turned off. In addition, the first node N1 is at a low level, and the first output transistor M9 is turned on. The first level signal Vgl may be transmitted to the shift signal output terminal Next, such that the shift signal Vnext may become a low level.

In this way, through the structure and related timing of the shift control module 110, the start time of the enable level of the shift control module 110 to control the shift output module 120 to output the shift signal Vnext may be located after the enable level start time of the input signal Vin received by the shift control module 110. The termination time of the enable level of the shift control module 110 to control the shift output module 120 to output the shift signal Vnext may be located after the termination time of the enable level of the input signal Vin received by the shift control module 110. Accordingly, the signal level transmission requirements of each stage of the shift register G may be satisfied.

Optionally, as shown in FIG. 23, the shift register G may also include a first reset module 160. The first reset module 160 is configured to at least receive a reset signal Vrst to reset the third node N3. In this way, before each level of driving circuit starts to output the enable level of the shift signal Vnext, the third node N3 of each stage of shift register G may be reset simultaneously or in a time-sharing manner. As such, the signal of the third node N3 of each stage of the shift register G may prepare for the shift register G of each level to accurately output the gate driving signal Gout.

Optionally, the first reset module 160 may include a first reset transistor M11. The gate of the first reset transistor M11 receives the reset signal Vrst, the first terminal of the first reset transistor M11 receives the second level signal Vgh, and the second terminal of the first reset transistor M11 is electrically connected to the third node N3.

The reset signal Vrst may be provided by the reset signal terminal RST. In this case, the gate of the first reset transistor M11 may be electrically connected to the reset signal terminal RST, such that the first reset transistor M11 may be turned on or off under the control of the reset signal Vrst of the reset signal terminal RST. When the reset signal Vrst controls the first reset transistor M11 to be turned on, the second level signal Vgh may be transmitted to the third node N3, such that the signal of the third node N3 may be consistent with the second level signal Vgh.

FIG. 24 illustrates a schematic structural diagram of another shift register consistent with the disclosed embodiments of the present disclosure. Referring to FIG. 24, the shift control module 110 may also include a second reset module 180. The second reset module 180 is configured to at least receive a reset signal Vrst to reset the first node N1. In this way, before each level of driving circuit starts to output the enable level of the shift signal Vnext, the first node N1 of each stage of shift register G may be reset simultaneously or in a time-sharing manner. Accordingly, the signal of the first node N1 of each stage of the shift register G may prepare for normal operation of each stage of the shift register G.

Optionally, the second reset module 180 may include a second reset transistor M12. The gate of the second reset transistor M12 receives the reset signal Vrst, the first terminal of the second reset transistor M12 receives the second level signal Vgh, and the second terminal of the second reset transistor M12 is electrically connected to the first node N1 or is electrically connected to the first node N1 through the first voltage regulating transistor M21.

The reset signal Vrst may be provided by the reset signal terminal RST. In this case, the gate of the second reset transistor M12 is electrically connected to the reset signal terminal RST, such that the second reset transistor M12 may be turned on or off under the control of the reset signal Vrst of the reset signal terminal RST. When the reset signal Vrst controls the second reset transistor M12 to be turned on, the second level signal Vgh may be transmitted to the first node N1. Accordingly, the signal of the first node N1 may be consistent with the second level signal Vgh.

Optionally, still referring to FIG. 24, the shift register G may also include a level holding module 170. The level holding module 170 is configured to maintain the signal of the third node N3, such that the signal of the third node N3 may continuously control the output control module 140. In one embodiment, the level holding module 170 includes a holding capacitor C1. The first plate of the holding capacitor C1 receives a fixed voltage signal, and the second plate of the holding capacitor C1 is electrically connected to the third node N3. The fixed voltage signal may multiplex the first level signal or the second level signal to reduce the number of signals provided to the shift register G and simplify the driving method of the shift register G.

Optionally, still referring to FIG. 24, the shift register G may also include a holding capacitor C3. The first plate of the holding capacitor C3 receives a fixed voltage signal, and the second plate is connected to the gate of the second output transistor M10. As a result, the holding capacitor C3 may maintain the gate signal of the second output transistor M10, such that when no new signal is written into the second node N2, the signal of the second node N2 may keep the second output transistor M10 be turned on or off. Accordingly, the output accuracy of the shift signal Vnext may be improved.

It should be noted that the above description is only an exemplary description of the modules provided in the shift register, and the structure and operation principle of each module; and the present disclosure are not limited thereto. Based on the above embodiments, corresponding modules may be added or removed. Provided that each stage of the shift register may accurately output gate driving signals, modifications of the above embodiments still fall within the protection scope of the present disclosure, and will not be elaborated here.

The present disclosure also provides a display device. The display device includes the display panel provided by the present disclosure. The display device may have the technical features and the driving method of the display panel provided by the present disclosure, and may achieve the beneficial effects of the display panel provided by the present disclosure. For details, reference may be made to the description of the display panel in the present disclosure, which will not be elaborated here.

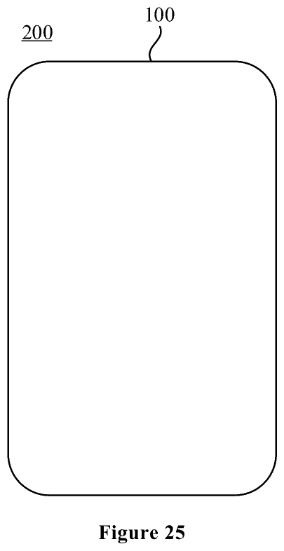

FIG. 25 illustrates a schematic structural diagram of a display device consistent with the disclosed embodiments of the present disclosure. As shown in FIG. 25, the display device 200 includes the display panel 100 provided by the present disclosure. The display device 200 provided in the present disclosure may be any electronic product with a display function, including but not limited to the following categories: mobile phones, TVs, laptops, desktop monitors, tablet computers, digital cameras, smart bracelets, smart glasses, car displays, medical equipment, industrial control equipment, touch interactive terminals, etc. The present disclosure does not limit a specific category of display devices.

As disclosed, the technical solutions of the present disclosure have the following advantages.

In the present disclosure, the display panel includes a driving circuit, which includes a cascaded N-stage shift register. The shift register at least includes a shift control module, a shift output module, an output control module and a signal output module. At least under the control of the input signal and the selection control signal, the shift output module may accurately output the shift signal, and the signal output module may accurately output the gate driving signal, such that the shift signal may not be affected by the gate driving signal. Accordingly, while the signal transmission between different stages of the shift registers may be realized, the gate driving signal output by the shift register at each stage may be flexibly controlled. As such, the display panel may meet diversified display requirements, and the application scenarios of the display panel may be broadened.

In addition, in the shift register, the signal output module may output the gate driving signal at least under the control of the output control module. When the gate driving signal includes an enable level, the enable level time of the gate driving signal may be consistent with the enable level time of the shift signal. As such, the situation where the signal writing in the display panel is inaccurate due to the short enable level time of the gate driving signal output may be avoided. Accordingly, accurate display of the display panel may be realized, and the display effect of the display panel may be improved.

The embodiments disclosed herein are exemplary only and not limiting the scope of the present disclosure. Various combinations, alternations, modifications, equivalents, or improvements to the technical solutions of the disclosed embodiments may be obvious to those skilled in the art. Without departing from the spirit and scope of this disclosure, such combinations, alternations, modifications, equivalents, or improvements to the disclosed embodiments are encompassed within the scope of the present disclosure.

What is claimed is:

1. A display panel, comprising a driving circuit, wherein the driving circuit includes a cascaded N-stage shift register, the cascaded N-stage shift register includes N stages of shift registers, and a stage of shift register of the N stages of shift registers includes:
a shift control module, configured to at least receive an input signal and control a signal of a first node and a signal of a second node;
a shift output module, configured to at least receive the signal of the first node and the signal of the second node, and control a shift signal;
a selection control module, configured to at least receive the shift signal and a selection control signal, and control a time for the selection control signal to be transmitted to the third node according to the shift signal;
an output control module, configured to at least receive the shift signal and a signal of a third node, and control a signal of a fourth node; and
a signal output module, configured to at least receive the signal of the fourth node, and control a gate driving signal,
wherein:
an enable level start time of the shift signal of each stage of shift register of the N stages of shift registers is shifted in sequence; and
the shift signal output by an x-th stage shift register of the N stages of shift registers is the input signal received by a y-th stage shift register of the N stages of shift registers, wherein 1≤x≤N, 1≤y≤N, x≠y, and x, y and N each are positive integers.

2. The display panel according to claim 1, wherein:
the selection control module includes a first selection transistor, wherein a first terminal of the first selection transistor receives the selection control signal, a second terminal of the first selection transistor is electrically connected to the third node, and a gate of the first selection transistor receives the shift signal.

3. The display panel according to claim 2, wherein:
the selection control module further includes a second selection transistor electrically connected between the first selection transistor and the third node, wherein a first terminal of the second selection transistor is electrically connected to the second terminal of the first selection transistor, a second terminal of the second selection transistor is electrically connected to the third node, and a gate of the second selection transistor receives a first control signal; and
in a same stage of shift register of the N stages of shift registers, a conduction time of the first selection transistor overlaps a conduction time of the second selection transistor.

4. The display panel according to claim 3, wherein:
in the same stage of shift register, an overlapping time of the conduction time of the first selection transistor and the conduction time of the second selection transistor is a selection input time; and
the selection input time of each stage of shifter register of the cascaded N-stage shift register is shifted in sequence.

5. The display panel according to claim 3, wherein:
a channel type of the first selection transistor is different from a channel type of the second selection transistor.

6. The display panel according to claim 3, wherein:
the input signal is multiplexed into the first control signal.

7. The display panel according to claim 6, wherein the shift output module includes a first
output transistor and a second output transistor, wherein:
a gate of the first output transistor is electrically connected to the first node, a first terminal of the first output transistor receives a first level signal, and a second terminal of the first output transistor is configured to output the shift signal;
a gate of the second output transistor is electrically connected to the second node, a first terminal of the second output transistor receives a second level signal, and a second terminal of the second output transistor is configured to output the shift signal; and
a channel type of the second selection transistor is different from a channel type of the first output transistor.

8. The display panel according to claim 1, wherein:
the output control module includes an NAND gate, wherein a first input terminal of the NAND gate receives the shift signal, a second input terminal of the NAND gate is electrically connected to the third node, and an output terminal of the NAND gate is electrically connected to the fourth node.

9. The display panel according to claim 8, wherein the NAND gate includes a first transistor, a second transistor, a third transistor and a fourth transistor, wherein;
a gate of the first transistor receives the shift signal, a gate of the second transistor is electrically connected to the third node, a first terminal of the first transistor receives a first level signal, a second terminal of the first transistor is electrically connected to a first terminal of the second transistor, and a second terminal of the second transistor is electrically connected to the fourth node;
a gate of the third transistor receives the shift signal, a gate of the fourth transistor is electrically connected to the third node, a first terminal of the third transistor receives a second level signal, and a second terminal of the third transistor and a second terminal of the fourth transistor each are electrically connected to the fourth node; and
a channel type of the first transistor is different from a channel type of the third transistor, and a channel type of the second transistor is different from a channel type of the fourth transistor.

10. The display panel according to claim 9, wherein:
channel types of the first transistor and the second transistor each are N-type.

11. The display panel according to claim 1, wherein:
the stage of shift register further includes a first reset module, wherein the first reset module is configured to at least receive a reset signal to reset the third node.

12. The display panel according to claim 11, wherein:
the first reset module includes a first reset transistor, wherein a gate of the first reset transistor receives the reset signal, a first terminal of the first reset transistor receives a second level signal, and a second terminal of the first reset transistor is electrically connected to the third node.

13. The display panel according to claim 1, wherein:
the stage of shift register further includes a level holding module, wherein the level holding module is configured to maintain a signal of the third node.

14. The display panel according to claim 13, wherein:
the level holding module includes a holding capacitor, wherein a first plate of the holding capacitor receives a fixed voltage signal, and a second plate of the holding capacitor is electrically connected to the third node.

15. The display panel according to claim 1, wherein the signal output module includes a third output transistor and a fourth output transistor, wherein:
a gate of the third output transistor is electrically connected to the first node, a first terminal of the third output transistor receives a first level signal, and a second terminal of the third output transistor is configured to output the gate driving signal; and
a gate of the fourth output transistor is electrically connected to the fourth node, a first terminal of the fourth output transistor receives a second level signal, and a second terminal of the fourth output transistor is configured to output the gate driving signal.

16. The display panel according to claim 1, wherein the shift control module includes a first shift control unit and a second shift control unit, wherein:
the first shift control unit is configured to at least receive the input signal, a first clock signal and a second clock signal, and control the signal of the first node; and
the second shift control unit is configured to at least receive the first clock signal, the second clock signal, a first level signal and the signal of the first node, and control the signal of the second node.

17. The display panel according to claim 1, further comprising a selection signal transmission line, wherein:
the selection signal transmission line is configured to transmit the selection control signal;
the selection control module of each stage of shift register of the cascaded N-stage shift register is electrically connected to the selection signal transmission line; and
a time when the selection control module of each stage of shift register of the cascaded N-stage shift register transmits the selection control signal to the third node is shifted sequentially.

18. The display panel according to claim 1, wherein:
a display mode of the display panel includes a first mode, wherein, in the first mode, the selection control signal includes an enable level and a non-enable level.

19. The display panel according to claim 18, wherein:
in the first mode, the cascaded N-stage shift register includes a first shift register and/or a second shift register;
a time when the selection control signal transits from the non-enable level to the enable level is between an enable level start time of the input signal of the first shift register and an enable level start time of the shift signal; and
a time when the selection control signal transits from the enable level to the non-enable level is between an enable level start time of the input signal of the second shift register and the enable level start time of the shift signal.

20. The display panel according to claim 1, wherein:
a display mode of the display panel includes a second mode, wherein, in the second mode, the selection control signal is at an enable level.

21. A display panel, comprising a driving circuit, wherein the driving circuit includes a cascaded N-stage shift register, the cascaded N-stage shift register includes N stages of shift registers, and a stage of shift register of the N stages of shift registers includes:
a shift control module, configured to at least receive an input signal, and control a signal of a first node and a signal of a second node;
a shift output module, configured to at least receive the signal of the first node and the signal of the second node, and control a shift signal;
an output control module, configured to at least receive a selection control signal and the shift signal, and control a signal of a fourth node; and
a signal output module, configured to at least receive the signal of the fourth node and control output of a gate driving signal,
wherein:
in a display time of a frame, in the cascaded N-stage shift register, the stage of shift register that outputs the gate driving signal that includes an enable level is a third shift register; and
in the third shift register, an enable level time of the gate driving signal is equal to an enable level time of the shift signal.

22. A display device, comprising a display panel, wherein the display panel includes a driving circuit, wherein the driving circuit includes a cascaded N-stage shift register, the cascaded N-stage shift register includes N stages of shift registers, and a stage of shift register of the N stages of shift registers includes:
a shift control module, configured to at least receive an input signal and control a signal of a first node and a signal of a second node; a shift output module, configured to at least receive the signal of the first node and the signal of the second node, and control a shift signal; a selection control module, configured to at least receive the shift signal and a selection control signal, and control a time for the selection control signal to be transmitted to the third node according to the shift signal; an output control module, configured to at least receive the shift signal and a signal of a third node, and control a signal of a fourth node; and a signal output module, configured to at least receive the signal of the fourth node, and control a gate driving signal, wherein: an enable level start time of the shift signal of each stage of shift register of the N stages of shift registers is shifted in sequence; and the shift signal output by an x-th stage shift register of the N stages of shift registers is the input signal received by a y-th stage shift register of the N stages of shift registers, wherein 1≤x≤N, 1≤y≤N, x≠y, and x, y and N each are positive integers; or
a shift control module, configured to at least receive an input signal, and control a signal of a first node and a signal of a second node; a shift output module, configured to at least receive the signal of the first node and the signal of the second node, and control a shift signal; an output control module, configured to at least receive a selection control signal and the shift signal, and control a signal of a fourth node; and a signal output module, configured to at least receive the signal of the fourth node and control output of a gate driving signal, wherein: in a display time of a frame, in the cascaded N-stage shift register, the stage of shift register that outputs the gate driving signal that includes an enable level is a third shift register; and in the third shift register, an enable level time of the gate driving signal is equal to an enable level time of the shift signal.
